(19) United States
(12) Patent Application Publication
(10) Pub. No.: US 2025/0279046 A1
(43) Pub. Date: Sep. 4, 2025

(54) DISPLAY DEVICE

(71) Applicant: SAMSUNG DISPLAY CO., LTD., YONGIN-SI (KR)

(72) Inventor: Sang Yong NO, Yongin-si (KR)

(21) Appl. No.: 18/829,659

(22) Filed: Sep. 10, 2024

(30) Foreign Application Priority Data
Feb. 29, 2024 (KR) 10-2024-0029966

(51) Int. Cl. G09G 3/3233; G09G 3/20; G09G 3/3266

(52) U.S. Cl. CPC G09G 3/3233; G09G 3/2096; G09G 3/3266; G09G 2300/0819; G09G 2300/0852; G09G 2300/0861; G09G 2310/0286; G09G 2310/08; G09G 2330/021

(57) ABSTRACT

A display device includes a first scan driver, a light emitting driver, and pixels that receive data voltages in response to first scan signals at a turn-on level and are in a non-emitting state in response to light emitting signals applied at a turn-off level. The light emitting driver includes a plurality of light emitting stages. During first scan periods, the light emitting stages sequentially generate light emitting signals of the turn-off level in units of one light emitting stage, and during second scan periods, the light emitting stages sequentially generate light emitting signals of the turn-off level in units of m light emitting stages, where m is an integer greater than 1.

### CROSS-REFERENCE TO RELATED APPLICATION

This application claims priority to and the benefit of Korean Patent Application No. 10-2024-0029966 filed in the Korean Intellectual Property Office on Feb. 29, 2024, the entire contents of which are incorporated by reference herein.

### TECHNICAL FIELD

This disclosure relates generally to a display device and more particularly to a display device with low power consumption capability.

### DISCUSSION OF RELATED ART

Modern display devices such as liquid crystal display (LCD) devices and organic light emitting diode (OLED) display devices have improved dramatically in terms of resolution and display quality, functionality, etc., in recent years.

As the configuration of display devices has become more diverse and complex, e.g., with higher resolution and circuit complexity to produce sharper and more realistic images, the power required to support an advanced display device has increased.

### SUMMARY

An aspect of the present disclosure is to provide a display device capable of reducing power consumption.

A display device according to an embodiment of the present disclosure includes a first scan driver configured to transmit first scan signals at a turn-on level during first scan periods and to maintain the first scan signals at a turn-off level during second scan periods; a light emitting driver configured to transmit light emitting signals at a turn-off level to overlap the first scan signals at the turn-on level during the first scan periods and to transmit the light emitting signals at the turn-off level during the second scan periods; and pixels configured to receive data voltages in response to the first scan signals at the turn-on level and to be in a non-emitting state in response to the light emitting signals at the turn-off level. The light emitting driver includes a plurality of light emitting stages. During the first scan periods, the light emitting stages sequentially generate light emitting signals of the turn-off level in units of one light emitting stage, and during the second scan periods, the light emitting stages sequentially generate light emitting signals of the turn-off level in units of m light emitting stages, and the m is an integer greater than 1.

In various embodiments:

The integer m may be a multiple of 2.

The light emitting driver may be connected to a first light emitting clock line, a second light emitting clock line, a third light emitting clock line, and a fourth light emitting clock line, each of the light emitting stages may include a first input terminal that receives a light emitting signal at the turn-off level output from another light emitting stage, a second input terminal that is connected to one of the first light emitting clock line, the second light emitting clock line, the third light emitting clock line, and the fourth light emitting clock line, a third input terminal that is connected to another of the first light emitting clock line, the second light emitting clock line, the third light emitting clock line, and the fourth light emitting clock line, and an output terminal that outputs a light emitting signal at the turn-off level, and two light emitting stages adjacent to each other may be connected to different light emitting clock lines.

A first light emitting stage group may include the m light emitting stages, a second light emitting stage group adjacent to the first light emitting stage group may include the m different light emitting stages, and a structure in which the second light emitting stage group is connected to the light emitting clock lines may be mirror symmetrical to a structure in which the first light emitting stage group is connected to the light emitting clock lines.

A m-1-th light emitting stage of the first light emitting stage group may have a second input terminal connected to the first light emitting clock line and a third input terminal connected to the second light emitting clock line, a m-th light emitting stage of the first light emitting stage group may have a second input terminal connected to the third light emitting clock line and a third input terminal connected to the fourth light emitting clock line, a first light emitting stage of the second light emitting stage group may have a second input terminal connected to the fourth light emitting clock line and a third input terminal connected to the third light emitting clock line, and a second light emitting stage of the second light emitting stage group may have a second input terminal connected to the second light emitting clock line and a third input terminal connected to the first light emitting clock line.

A frequency of light emitting clock signals applied to the light emitting clock lines during the first scan periods may be m times a frequency of the light emitting clock signals applied to the light emitting clock lines during the second scan periods.

During the first scan periods, a first light emitting clock signal applied to the first light emitting clock line may be the same as a fourth light emitting clock signal applied to the fourth light emitting clock line, and a second light emitting clock signal applied to the second light emitting clock line may be the same as a third light emitting clock signal applied to the third light emitting clock line, and during the second scan periods, the first light emitting clock signal may be the same as the third light emitting clock signal, and the second light emitting clock signal may be the same as the fourth light emitting clock signal.

The light emitting driver may further include a light emitting stage connection circuit that receives an enable signal during the first scan periods and a disable signal during the second scan periods, when receiving the enable signal, the light emitting stage connection circuit may connect each of first input terminals of the light emitting stages to an output terminal of a previous light emitting stage, and when receiving the disable signal, the light emitting stage connection circuit may connect each of the first input terminals of the light emitting stages to an output terminal of a previous light emitting stage group.

The light emitting stage connection circuit may include first connection transistors that are turned on when receiving the enable signal and connect each of the first input terminals of the light emitting stages to the output terminal of the previous light emitting stage, and second connection transistors that are turned on when receiving the disable signal and connect each of the first input terminals of the light emitting stages to the output terminal of the previous light emitting stage group.

The first connection transistors may be first conductive transistors, the second connection transistors may be second conductive transistors, the second connection transistors may be second conductive transistors, gate electrodes of the first connection transistors and of the second connection transistors may be commonly connected to an enable line, the enable signal and the disable signal may be applied to the enable line, the enable signal may be a signal of polarity that turns on the first conductive transistors, and the disable signal may be a signal of opposite polarity that turns on the second conductive transistors.

A display device according to an embodiment of the present disclosure includes a first scan driver that transmits first scan signals at a turn-on level during first scan periods and maintains the first scan signals at a turn-off level during second scan periods; a second scan driver that transmits second scan signals at a turn-on level during the first scan periods and transmits second scan signals at the turn-on level during the second scan periods; and pixels that receive data voltages in response to the first scan signals at the turn-on level and initialize an anode voltage of a light emitting element in response to the second scan signals at the turn-on level, wherein the second scan driver includes a plurality of scan stages, during the first scan periods, the scan stages sequentially generate second scan signals at the turn-on level in units of one scan stage, during the second scan periods, the scan stages sequentially generate second scan signals at the turn-on level in units of m scan stages, where m is an integer greater than 1.

The m may be a multiple of 2.

The second scan driver may be connected to a first scan clock line, a second scan clock line, a third scan clock line, and a fourth scan clock line, each of the scan stages may include a first input terminal that receives a second scan signal at the turn-on level output from another scan stage, a second input terminal that is connected to one of the first scan clock line, the second scan clock line, the third scan clock line, and the fourth scan clock line, a third input terminal that is connected to another one of the first scan clock line, the second scan clock line, the third scan clock line, and the fourth scan clock line, and an output terminal that outputs a second scan signal at the turn-on level, and two scan stages adjacent to each other may be connected to different scan clock lines.

The m-1-th scan stage of the first scan stage group may have a second input terminal connected to the first scan clock line and a third input terminal connected to the second scan clock line, a m-th scan stage of the first scan stage group may have a second input terminal connected to the third scan clock line and a third input terminal connected to the fourth scan clock line, a first scan stage of the second scan stage group may have a second input terminal connected to the fourth scan clock line and a third input terminal connected to the third scan clock line, and a second scan stage of the second scan stage group may have a second input terminal connected to the second scan clock line and a third input terminal connected to the first scan clock line.

A frequency of scan clock signals applied to the scan clock lines during the first scan periods may be m times a frequency of the scan clock signals applied to the scan clock lines during the second scan periods.

During the first scan periods, a first scan clock signal applied to the first scan clock line may be the same as a fourth scan clock signal applied to the fourth scan clock line, and a second scan clock signal applied to the second scan clock line may be the same as a third scan clock signal applied to the third scan clock line, and during the second scan periods, the first scan clock signal may be the same as the third scan clock signal, and the second scan clock signal may be the same as the fourth scan clock signal.

The second scan driver may be connected to a first scan clock line, a second scan clock line, a third scan clock line, and a fourth scan clock line, each of the scan stages may include a first input terminal that receives a second scan signal at the turn-on level output from another scan stage, a second input terminal that is connected to one of the first scan clock line, the second scan clock line, the third scan clock line, and the fourth scan clock line, and an output terminal that outputs a second scan signal at the turn-on level, and two scan stages adjacent to each other may be connected to different scan clock lines.

A m-1-th scan stage of the first scan stage group may have a second input terminal connected to the first scan clock line, a m-th scan stage of the first scan stage group may have a second input terminal connected to the third scan clock line, a first scan stage of the second scan stage group may have a second input terminal connected to the fourth scan clock line, and a second scan stage of the second scan stage group may have a second input terminal connected to the second scan clock line.

The second scan driver may further include a scan stage connection circuit that receives an enable signal during the first scan periods and a disable signal during the second scan periods, when receiving the enable signal, the scan stage connection circuit may connect each of first input terminals of the scan stages to an output terminal of a previous scan stage, and when receiving the disable signal, the scan stage connection circuit may connect each of the first input terminals of the scan stages to an output terminal of a previous scan stage group.

The scan stage connection circuit may include first connection transistors that are turned on when receiving the enable signal and connect each of the first input terminals of the scan stages to the output terminal of the previous scan stage, and second connection transistors that are turned on when receiving the disable signal and connect each of the first input terminals of the scan stages to the output terminal of the previous scan stage group.

In an embodiment, a display device may include: a scan driver configured to transmit scan signals at a turn-on level during respective portions of first scan periods and to provide the scan signals at a turn-off level throughout each of second scan periods; a light emitting driver configured to transmit light emitting signals at a turn-off level at time periods overlapping time periods at which the scan signals are at the turn-on level during the first scan periods, and to transmit the light emitting signals at the turn-off level throughout the second scan periods; and pixels configured to receive data voltages in response to the scan signals at the turn-on level and to be in a non-emitting state in response to the light emitting signals at the turn-off level. The light emitting driver includes a plurality of light emitting stages. During the first scan periods, the light emitting stages sequentially generate light emitting signals of the turn-off level in units of one light emitting stage, and during the second scan periods, the light emitting stages sequentially generate light emitting signals of the turn-off level in units of m light emitting stages, where m is an integer greater than 1.

A display device according to the present disclosure may operate with reduced power consumption relative to conventional displays.

### BRIEF DESCRIPTION OF THE DRAWINGS

FIG. 1 is a schematic diagram illustrating a display device according to an embodiment of the present disclosure.

FIG. 2 is a schematic diagram illustrating a pixel according to an embodiment of the present disclosure.

FIG. 3 is a timing diagram illustrating a method of changing a display frequency according to an embodiment of the present disclosure.

FIG. 4 is a signal/timing diagram illustrating a first scan period according to an embodiment of the present disclosure.

FIG. 5 is a signal/timing diagram illustrating a second scan period according to an embodiment of the present disclosure.

FIG. 6 is a signal/timing diagram illustrating a first scan period and a second scan period according to another embodiment of the present disclosure.

FIG. 7 is a schematic diagram illustrating a light emitting driver according to an embodiment of the present disclosure.

FIG. 8 is a schematic diagram illustrating a light emitting stage according to an embodiment of the present disclosure.

FIG. 9 is a signal/timing diagram illustrating a driving method of a light emitting stage of FIG. 8.

FIG. 10 is a signal/timing diagram illustrating a driving method of a light emitting driver composed of light emitting stages of FIG. 8.

FIG. 11 is a schematic diagram illustrating a light emitting stage according to another embodiment of the present disclosure.

FIG. 12 is a signal/timing diagram illustrating a driving method of a light emitting stage of FIG. 11.

FIG. 13 is a signal/timing diagram illustrating a driving method of a light emitting driver composed of a light emitting stages of FIG. 11.

FIG. 14 is a schematic diagram illustrating a second scan driver according to an embodiment of the present disclosure.

FIG. 15 is a schematic diagram illustrating a scan stage according to an embodiment of the present disclosure.

FIG. 16 is a signal/timing diagram illustrating a driving method of a scan stage of FIG. 15.

FIG. 17 is a signal/timing illustrating a driving method of a second scan driver composed of a scan stage of FIG. 15.

FIG. 18 is a signal/timing diagram illustrating a second scan driver according to another embodiment of the present disclosure.

FIG. 19 is a schematic diagram illustrating a scan stage according to another embodiment of the present disclosure.

FIG. 20 is a signal/timing diagram illustrating a driving method of a scan stage of FIG. 19.

### DETAILED DESCRIPTION OF EMBODIMENTS

Hereinafter, with reference to accompanying drawings, various embodiments of the present disclosure will be described in detail so that those skilled in the art can easily carry out the present disclosure. The present disclosure may be embodied in many different forms and is not limited to the embodiments described herein.

To clearly illustrate the present disclosure, description of known components unrelated to the novel aspects of the disclosure may be omitted or briefly discussed. The same or similar constituent elements are given the same reference numerals throughout the specification.

In addition, the size and thickness of each configuration shown in the drawing may be arbitrarily shown for better understanding and ease of description, and the present disclosure is not limited to the illustrated embodiments. In the drawings, the dimensions of layers and regions may be exaggerated for clarity of illustration.

In addition, the expression “the same” in the description may mean “substantially the same”. For example, it may be the same degree to which a person with ordinary knowledge would understand as the same.

In the following description, various elements of the same or similar type (e.g., a scan stage GBT) may be distinguished by annexing the reference label (e.g., GBT) with a second label (e.g., n1 to describe a scan stage GBTn1). However, if a given description uses only the first reference label (e.g., GBT), it is applicable to any one of the same/similar elements having the same first reference label irrespective of the second label.

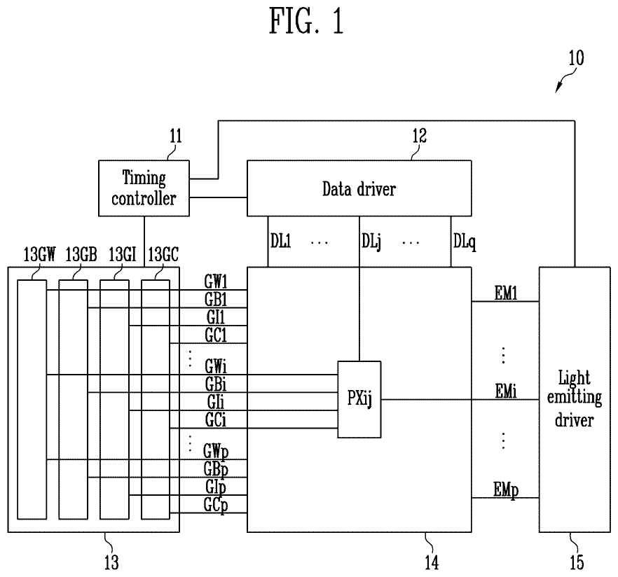

FIG. 1 is a schematic diagram illustrating a display device, 10, according to an embodiment of the present disclosure. The display device 10 may include a timing controller 11, a data driver 12, a scan driver 13, a pixel unit 14, and a light emitting driver 15.

The timing controller 11 may receive grayscales for an input image (or input frame). The grayscales may include a first color grayscale, a second color grayscale, and a third color grayscale. The first, second and third color grayscale may be grayscales for expressing first, second and third colors, respectively.

Additionally, the timing controller 11 may receive a control signal for the image. These control signals may include a horizontal synchronization signal (Hsync), a vertical synchronization signal (Vsync), and a data enable signal. The vertical synchronization signal may include a plurality of pulses, and may indicate that the previous frame period ends and the current frame period starts based on the time when each pulse occurs. An interval between adjacent pulses in the vertical synchronization signal may correspond to one frame period. The horizontal synchronization signal may include a plurality of pulses, and may indicate that the previous horizontal period ends and a new horizontal period starts based on the time when each pulse occurs. An interval between adjacent pulses of the horizontal synchronization signal may correspond to one horizontal period. The data enable signal may have an enable level for certain horizontal periods and a disable level for the remaining periods. It may indicate that color grayscales are supplied in the corresponding horizontal periods, when the data enable signal is at an enable level.

The timing controller 11 may provide grayscales rendered or corrected to meet the specifications of the display device 10 to the data driver 12. Additionally, the timing controller 11 may provide a clock signal, a scan start signal, etc. to the scan driver 13. The timing controller 11 may provide a clock signal, a light emitting stop signal, etc. to the light emitting driver 15.

The data driver 12 may generate data voltages to be provided to the data lines DL1, . . . , DLj, . . . , DLq using the grayscales and control signals received from the timing controller 11. For example, the data driver 12 may sample grayscales using a clock signal and may apply data voltages corresponding to the grayscales to data lines in units of pixel rows. q may be an integer greater than 1, and j may be an integer greater than 0 and less than q.

The scan driver 13 may include first to fourth scan drivers 13GW, 13 GB, 13GI, and 13GC. The first scan driver 13GW may provide first scan signals to the first scan lines GW1, . . . , GWi, . . . , and GWp. p may be an integer greater than 1, and i may be an integer greater than 0 and less than p. The second scan driver 13 GB may provide second scan signals to the second scan lines GB1, . . . , GBi, . . . , and GBp. The third scan driver 13GI may provide third scan signals to the third scan lines GI1, . . . , GIi, . . . , and GIp. The fourth scan driver 13GC may provide fourth scan signals to the fourth scan lines GC1, . . . , GCi, . . . , GCp.

For example, the first scan driver 13GW may receive at least one scan clock signal and scan start signal from the timing controller 11 and, based on these signals, may generate first scan signals to be provided to the first scan lines GW1 to GWp. The first scan driver 13GW may sequentially provide the first scan signals having a turn-on level pulse to the first scan lines GW1 to GWp. For example, the first scan driver 13GW may be configured in the form of a shift register, and may generate the first scan signals in a manner that sequentially transmits the scan start signal, which may be a pulse with a turn-on level (“a turn-on level pulse”), to the next scan stage depending on a control of the scan clock signal.

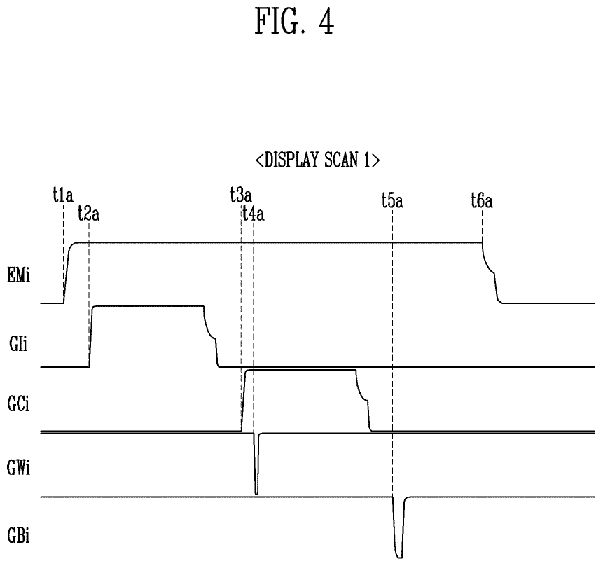

Each of the second scan driver 13 GB, the third scan driver 13GI, and the fourth scan driver 13GC may be configured similarly to the first scan driver 13GW, so duplicate descriptions will be omitted. According to an embodiment, at least some of the first to fourth scan drivers 13GW, 13 GB, 13GI, and 13GC may be integrated. For example, when the polarity and width of the pulses are the same, two or more scan drivers may be integrated. For example, referring momentarily to FIG. 4, since the polarity and width at the turn-on level pulse applied to the third scan line GIi at time t2a and the turn-on level pulse applied to the fourth scan line GCi at time t3a are the same, the third scan driver 13GI and the fourth scan driver 13GC may be integrated.

The light emitting driver 15 may receive at least one light emitting clock signal and light emitting stop signal from the timing controller 11 and may generate light emitting signals to be provided to the light emitting lines EM1, . . . , EMi, . . . , and EMp. The light emitting driver 15 may sequentially provide the light emitting signals having a “turn-off level pulse” to the light emitting lines EM1 to EMp. For example, the light emitting driver 15 may be configured in the form of a shift register, and may generate the light emitting signals in a manner that sequentially transmits the light emitting stop signal, which includes a turn-off level pulse, to the next light emitting stage depending on a control of the light emitting clock signal.

In FIG. 1, the number of each of the first scan lines GW1 to GWp, the second scan lines GB1 to GBp, the third scan lines GI1 to GIp, the fourth scan lines GC1 to GCp, and the light emitting lines EM1 to EMp is shown as p. In another embodiment, the number of at least one of the second scan lines GB1 to GBp, the third scan lines GI1 to GIp, the fourth scan lines GC1 to GCp, and the light emitting lines EM1 to EMp is p/2 or less. For example, two adjacent pixel rows may share one second scan line. Similarly, two adjacent pixel rows may share one third scan line, fourth scan line, or light emitting line. The same pixel row refers to pixels connected to the same first scan line. Hereinafter, as an example for ease of description, each of the first scan lines GW1 to GWp, the second scan lines GB1 to GBp, the third scan lines GI1 to GIp, the fourth scan lines GC1 to GCp, and the light emitting lines EM1 to EMp will be described as consisting of p lines.

The pixel unit 14 includes a plurality of pixels. Each pixel PXij may be connected to a corresponding data line DLj, scan lines GWi, GBi, GIi, and GCi, and light emitting line EMi. The pixel unit 14 may include first pixels that emit light of a first color, second pixels that emit light of a second color, and third pixels that emit light of a third color. Examples of the first to third colors may be red, green and blue; or magenta, cyan, and yellow.

The pixel unit 14 may have pixels arranged in any of various shapes such as diamond PENTILE™, RGB-Stripe, S-stripe, Real RGB, normal PENTILE™, and the like.

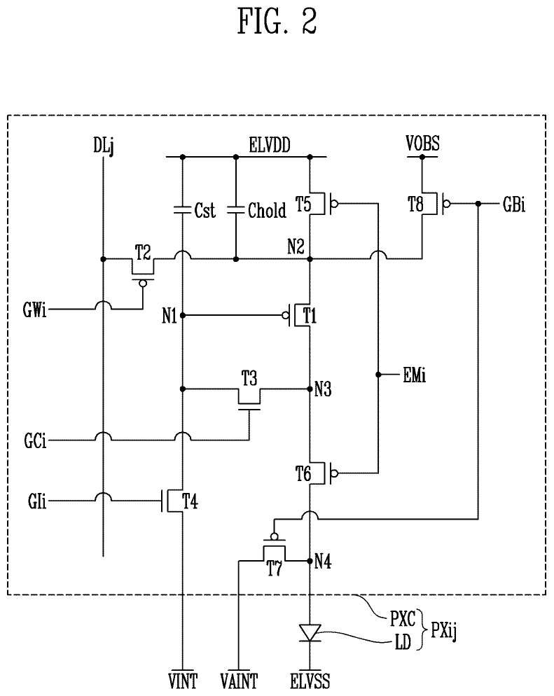

FIG. 2 is a schematic diagram illustrating a pixel according to an embodiment of the present disclosure. In the various schematic diagrams herein including field effect transistors (FETs), an FET with a circle at its gate may be a P-type FET and an FET without a circle at its gate may be an N-type FET.

Referring to FIG. 2, the pixel PXij may include a pixel circuit PXC and a light emitting element LD. The pixel circuit PXC may include a storage capacitor Cst, a hold capacitor Chold, and transistors T1-T8, of which transistors T3 and T4 are N-type transistors and transistors T1, T2, and T5-T8 are P-type transistors. In other embodiments, the hold capacitor Chold is omitted.

The pixel PXij may be disposed in the i-th pixel row and in the j-th pixel column. The pixel PXij may be an example of any of the first to third pixels for expressing the first to third colors, respectively.

In this embodiment, the P-type transistors may be polysilicon semiconductor transistors. In a polysilicon semiconductor transistor, the channel of the active layer may include a polysilicon semiconductor. For example, the poly-silicon semiconductor transistor may be a low temperature poly-silicon (LTPS) thin film transistor. Polysilicon semiconductor transistors have high electron mobility and thus have fast driving characteristics.

In this embodiment, the N-type transistors may be oxide semiconductor transistors. In an oxide semiconductor transistor, the channel of the active layer may include an oxide semiconductor. For example, the oxide transistor may be a low temperature polycrystalline oxide (LTPO) thin film transistor. Oxide semiconductor transistors have lower charge mobility than polysilicon semiconductor transistors. Accordingly, the amount of leakage current generated in the turn-off state of oxide semiconductor transistors may be smaller than that of polysilicon semiconductor transistors.

The first transistor T1 may include a gate electrode connected to a first node N1, a first electrode connected to a second node N2, and a second electrode connected to a third node N3. The first transistor T1 may be a driving transistor.

The second transistor T2 may have a gate electrode connected to the first scan line GWi, a first electrode connected to the data line DLj, and a second electrode connected to the second node N2. The second transistor T2 may be a scan transistor.

The third transistor T3 may have a gate electrode connected to the fourth scan line GCi, a first electrode connected to the first node N1, and a second electrode connected to the third node N3. The third transistor T3 may be a “diode-connection” transistor. This is because when the third transistor T3 is turned on, the transistor T1 becomes a diode-connected transistor.

The fourth transistor T4 has a gate electrode connected to the third scan line GIi, a first electrode connected to the first node N1, and a second electrode receiving the first initialization voltage VINT. The fourth transistor T4 may be a gate initialization transistor. The fourth transistor T4 may be an N-type transistor.

The fifth transistor T5 may have a gate electrode connected to the light emitting line EMi, a first electrode receiving the first power voltage ELVDD, and a second electrode connected to the second node N2. The fifth transistor T5 may be the first light emitting control transistor. The fifth transistor T5 may be a P-type transistor.

The sixth transistor T6 may have a gate electrode connected to the light emitting line EMi, a first electrode connected to the third node N3, and a second electrode connected to the fourth node N4. The sixth transistor T6 may be a second light emitting control transistor. The sixth transistor T6 may be a P-type transistor.

The seventh transistor T7 may have a gate electrode connected to the second scan line GBi, a first electrode receiving the second initialization voltage VAINT, and a second electrode connected to the fourth node N4. The seventh transistor T7 may be an anode initialization transistor. The seventh transistor T7 may be a P-type transistor.

The eighth transistor T8 may have a gate electrode connected to the second scan line GBi, a first electrode receiving the bias voltage VOBS, and a second electrode connected to the second node N2. The eighth transistor T8 may be a P-type transistor.

The storage capacitor Cst may have a first electrode receiving the first power voltage ELVDD, and a second electrode connected to the first node N1.

A first electrode of the hold capacitor Chold may receive the first power voltage ELVDD, and a second electrode thereof may be connected to the second node N2.

The anode of the light emitting element LD may be connected to the fourth node N4, and the cathode thereof may receive the second power voltage ELVSS. The light emitting element LD may emit light in one of a first color, a second color, and a third color. The light emitting element LD may be a light emitting diode. The light emitting element LD may include an organic light emitting diode, an inorganic light emitting diode, a quantum dot/well light emitting diode, or the like. In this embodiment, each pixel may include only one light emitting element LD, but in other embodiments, each pixel may include a plurality of light emitting elements. In this case, the plurality of light emitting elements may be connected in series, parallel, series-parallel, or the like.

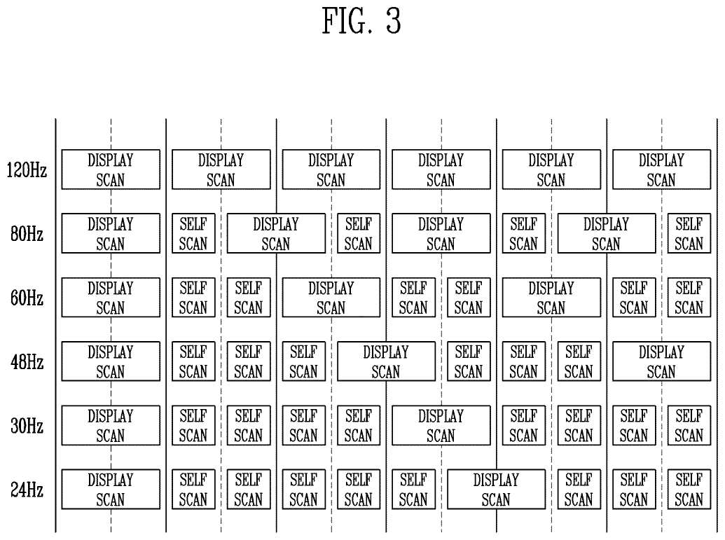

FIG. 3 is a timing diagram illustrating a method of changing a display frequency according to an embodiment of the present disclosure.

Referring to FIG. 3, the display device 10 may change the display frequency using first scan periods DISPLAY SCAN and second scan periods SELF SCAN.

The first scan period DISPLAY SCAN may be a period in which the pixels of the pixel unit 14 receive data voltages. Accordingly, when a new first scan period DISPLAY SCAN starts, the image frame displayed by the pixel unit 14 may change. Accordingly, the cycle of the first scan periods DISPLAY SCAN may be the same as the display frequency. For example, during the first scan period DISPLAY SCAN, the first to fourth scan drivers 13GW, 13 GB, 13GI, and 13GC may transmit scan signals at the turn-on level. Additionally, during the first scan period DISPLAY SCAN, the light emitting driver 15 may transmit light emitting signals at the turn-off level to overlap first scan signals at the turn-on level (see FIG. 4).

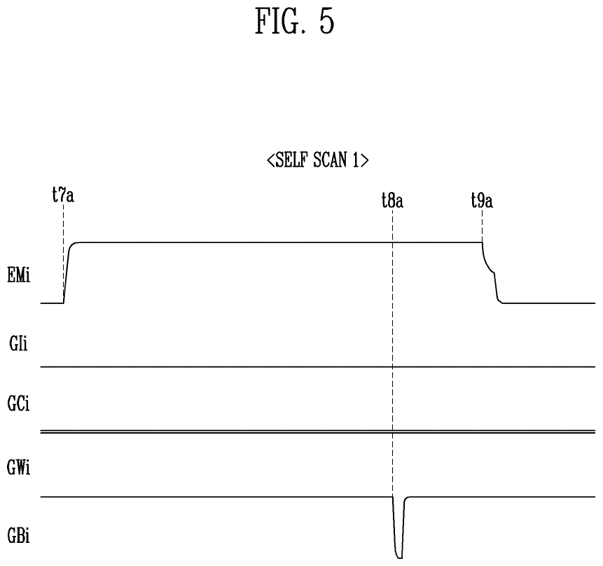

The second scan period SELF SCAN may be a period in which the pixels of the pixel unit 14 do not receive data voltages. For example, during the second scan periods SELF SCAN, the first scan driver 13GW, the third scan driver 13GI, and the fourth scan driver 13GC may maintain scan signals at the turn-off level. Meanwhile, during the second scan period SELF SCAN, the second scan driver 13 GB may transmit second scan signals at the turn-on level, and the light emitting driver 15 may transmit light emitting signals at the turn-off level (see FIG. 5).

In FIG. 3, a case where one first scan period DISPLAY SCAN is approximately 1/120 second is illustrated. In this case, when the first scan period DISPLAY SCAN is repeated without the second scan period SELF SCAN, the display device 10 may display an image with the display frequency of 120 Hz. As the number of second scan periods SELF SCAN disposed between adjacent first scan periods DISPLAY SCAN increases, the display frequency may decrease.

FIG. 4 is a signal/timing diagram illustrating a first scan period according to an embodiment of the present disclosure. In describing FIG. 4, the pixel PXij of FIG. 2 is referred to.

At time t1a, the light emitting signal at the turn-off level (high level) may be applied to the light emitting line EMi, so that the fifth transistor T5 and the sixth transistor T6 may be turned off, and the pixel PXij may be in a non-emitting state.

At time t2a, the third scan signal at the turn-on level (high level) may be applied to the third scan line GIi, so that the fourth transistor T4 may be turned on. Accordingly, the first initialization voltage VINT may be applied to the first node N1. The first initialization voltage VINT may be a sufficiently low voltage and may thereby bias the first transistor T1 to a turned-on state (hereafter, an “on-bias state”).

At time t3a, the fourth scan signal at the turn-on level (high level) may be applied to the fourth scan line GCi, so that the third transistor T3 may be turned on. Accordingly, the first transistor T1 may be in a diode-connected state in which the drain electrode and the gate electrode are connected.

At time t4a, a scan signal at the turn-on level (low level) may be applied to the first scan line GWi, so that the second transistor T2 may be turned on. Accordingly, the data voltage of the data line DLj may be applied to the first node N1 through the second transistor T2, the first transistor T1, and the third transistor T3 that are turned on. (Note that as shown in FIG. 4, the time period during which the first scan line GWi is at the turn-on level beginning at time t4a may be a small portion of the time of the entire DISPLAY SCAN.) At this time, the voltage of the first node N1 may be a compensation voltage obtained by subtracting the threshold voltage of the first transistor T1 from the data voltage. The storage capacitor Cst may maintain the difference between the first power voltage ELVDD and the compensation voltage.

At time t5a, a scan signal at the turn-on level (low level) may be applied to the second scan line GBi, so that the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

Additionally, as the eighth transistor T8 is turned on, the voltage of the second node N2 may be set to the bias voltage VOBS. Accordingly, since the bias voltage VOBS, rather than the data voltage of the previous frame period, is applied to the source electrode of the first transistor T1, the hysteresis phenomenon may be prevented and the on-bias state may be guaranteed.

At time t6a, the light emitting signal at the turn-on level (low level) may be applied to the light emitting line EMi, so that the fifth transistor T5 and the sixth transistor T6 may be turned on. Accordingly, a path for driving current which flows from the first power voltage ELVDD via the fifth transistor T5, the first transistor T1, the sixth transistor T6, and the light emitting element LD to the second power voltage ELVSS, may be formed.

The amount of driving current may be adjusted depending on the voltage maintained in the storage capacitor Cst. The light emitting element LD may emit light with a luminance corresponding to the amount of driving current. The light emitting element LD may emit light until the light emitting signal at the turn-off level is applied to the light emitting line EMi.

FIG. 5 is a signal/timing diagram illustrating a second scan period according to an embodiment of the present disclosure. In describing FIG. 5, the pixel PXij of FIG. 2 is referred to.

At time t7a, the light emitting signal at the turn-off level (high level) may be applied to the light emitting line EMi, so that the fifth transistor T5 and the sixth transistor T6 may be turned off, and the pixel PXij may be in a non-emitting state.

During the period t7a to t8a, scan signals at the turn-off level may be maintained in the first scan line GWi, the third scan line GIi, and the fourth scan line GCi. Accordingly, the voltage of the first node N1 does not vary.

At time t8a, a scan signal at the turn-on level (low level) may be applied to the second scan line GBi, so that the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

Additionally, as the eighth transistor T8 is turned on, the voltage of the second node N2 may be set to the bias voltage VOBS. Accordingly, since the bias voltage VOBS, rather than the data voltage of the previous frame period, is applied to the source electrode of the first transistor T1, the hysteresis phenomenon may be prevented and the on-bias state may be guaranteed.

At time t9a, the light emitting signal at the turn-on level (low level) may be applied to the light emitting line EMi, so that the fifth transistor T5 and the sixth transistor T6 may be turned on. Accordingly, a path for driving current which flows from the first power voltage ELVDD via the fifth transistor T5, the first transistor T1, the sixth transistor T6, and the light emitting element LD to the second power voltage ELVSS, may be formed.

The amount of driving current may be adjusted depending on the voltage maintained in the storage capacitor Cst. Since the voltage of the first node N1 recorded during the first scan period DISPLAY SCAN 1 is maintained during the second scan period SELF SCAN 1, the image frame displayed by the pixel unit 14 during the second scan period SELF SCAN 1 may be the same as the image frame displayed by the pixel unit 14 during the first scan period DISPLAY SCAN 1.

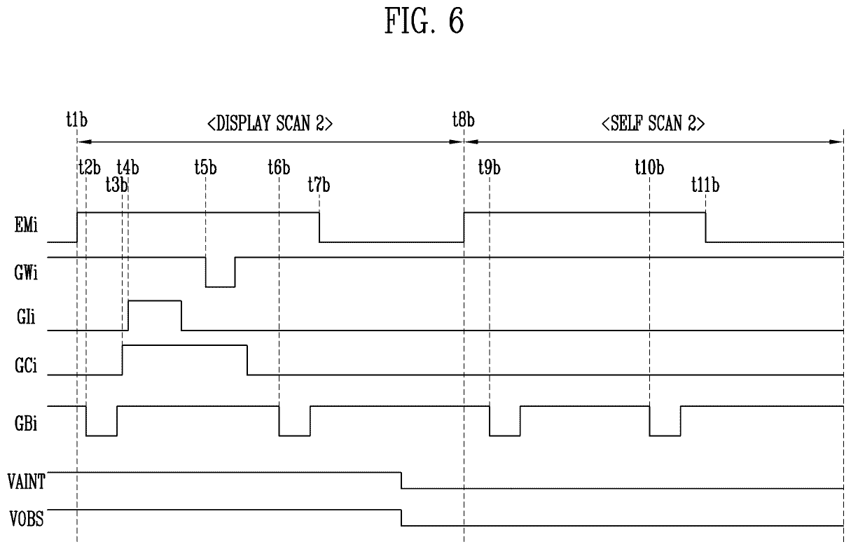

FIG. 6 is a signal/timing diagram illustrating a first scan period and a second scan period according to another embodiment of the present disclosure. In describing FIG. 6, the pixel PXij of FIG. 2 is referred to.

First, the first scan period DISPLAY SCAN 2 will be described.

At time t1b, the light emitting signal at the turn-off level (high level) is applied to the light emitting line EMi, so that the fifth transistor T5 and the sixth transistor T6 may be turned off, and the pixel PXij may be in a non-emitting state.

At time t2b, the scan signal at the turn-on level (low level) is applied to the second scan line GBi, so that turning on the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

At time t3b, the fourth scan signal at the turn-on level (high level) is applied to the fourth scan line GCi, so that the third transistor T3 may be turned on. Accordingly, the first transistor T1 may be in a diode-connected state in which the drain electrode and the gate electrode are connected.

At time t4b, the third scan signal at the turn-on level (high level) is applied to the third scan line GIi, so that the fourth transistor T4 may be turned on. Accordingly, the first initialization voltage VINT may be applied to the first node N1. The first initialization voltage VINT may be a sufficiently low voltage and may turn on-bias the first transistor T1.

At time t5b, the scan signal at the turn-on level (low level) is applied to the first scan line GWi, so that the second transistor T2 may be turned on. Accordingly, the data voltage of the data line DLj may be applied to the first node N1 through the second transistor T2, the first transistor T1, and the third transistor T3 that are turned on. At this time, the voltage of the first node N1 may be a compensation voltage obtained by subtracting the threshold voltage of the first transistor T1 from the data voltage. The storage capacitor Cst may maintain the difference between the first power voltage ELVDD and the compensation voltage.

At time t6b, the scan signal at the turn-on level (low level) is applied to the second scan line GBi, so that the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

Additionally, as the eighth transistor T8 is turned on, the voltage of the second node N2 may be set to the bias voltage VOBS. Accordingly, since the bias voltage VOBS, rather than the data voltage of the previous frame period, is applied to the source electrode of the first transistor T1, the hysteresis phenomenon may be prevented and the on-bias state may be guaranteed.

At time t7b, the light emitting signal at the turn-on level (low level) is applied to the light emitting line EMi, so that the fifth transistor T5 and the sixth transistor T6 may be turned on. Accordingly, a path for driving current which flows from the first power voltage ELVDD via the fifth transistor T5, the first transistor T1, the sixth transistor T6, and the light emitting element LD to the second power voltage ELVSS, may be formed.

The amount of driving current may be adjusted depending on the voltage maintained in the storage capacitor Cst. The light emitting element LD may emit light with a luminance corresponding to the amount of driving current. The light emitting element LD may emit light until the light emitting signal at the turn-off level is applied to the light emitting line EMi.

Next, the second scan period SELF SCAN 2 will be described.

According to an embodiment of the present disclosure, before changing from the first scan period DISPLAY SCAN 2 to the second scan period SELF SCAN 2, at least one of the second initialization voltage VAINT and the bias voltage VOBS may be changed. For example, the second initialization voltage VAINT and the bias voltage VOBS may decrease. This may be to set the voltage stress applied to the first transistor T1 to the same level in the first scan period DISPLAY SCAN 2 and the second scan period SELF SCAN 2.

At time t8b, the light emitting signal at the turn-off level (high level) is applied to the light emitting line EMi, so that the fifth transistor T5 and the sixth transistor T6 may be turned off, and the pixel PXij may be in a non-emitting state.

At time t9b, the scan signal at the turn-on level (low level) is applied to the second scan line GBi, so that the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

Additionally, as the eighth transistor T8 is turned on, the voltage of the second node N2 may be set to the bias voltage VOBS. Accordingly, since the bias voltage VOBS, rather than the data voltage of the previous frame period, is applied to the source electrode of the first transistor T1, the hysteresis phenomenon may be prevented and the on-bias state may be guaranteed.

During the period t8b to t10b, scan signals at the turn-off level may be maintained in the first scan line GWi, the third scan line GIi, and the fourth scan line GCi. Accordingly, the voltage of the first node N1 does not vary.

At time t10b, the scan signal at the turn-on level (low level) is applied to the second scan line GBi, so that the seventh transistor T7 and the eighth transistor T8 may be turned on. As the seventh transistor T7 is turned on, the second initialization voltage VAINT may be applied to the anode of the light emitting element LD, and the light emitting element LD may be initialized to the amount of charge corresponding to the voltage difference between the second initialization voltage VAINT and the second power voltage ELVSS. Accordingly, low grayscale expression of the light emitting element LD may be facilitated.

Additionally, as the eighth transistor T8 is turned on, the voltage of the second node N2 may be set to the bias voltage VOBS. Accordingly, since the bias voltage VOBS, rather than the data voltage of the previous frame period, is applied to the source electrode of the first transistor T1, the hysteresis phenomenon may be prevented and the on-bias state may be guaranteed.

At time t11b, the light emitting signal at the turn-on level (low level) is applied to the light emitting line EMi, so that the fifth transistor T5 and the sixth transistor T6 may be turned on. Accordingly, a path for driving current which flows from the first power voltage ELVDD via the fifth transistor T5, the first transistor T1, the sixth transistor T6, and the light emitting element LD to the second power voltage ELVSS, may be formed.

The amount of driving current may be adjusted depending on the voltage maintained in the storage capacitor Cst. Since the voltage of the first node N1 recorded during the first scan period DISPLAY SCAN 2 is maintained during the second scan period SELF SCAN 2, the image frame displayed by the pixel unit 14 during the second scan period SELF SCAN 2 may be the same as the image frame displayed by the pixel unit 14 during the first scan period DISPLAY SCAN 2.

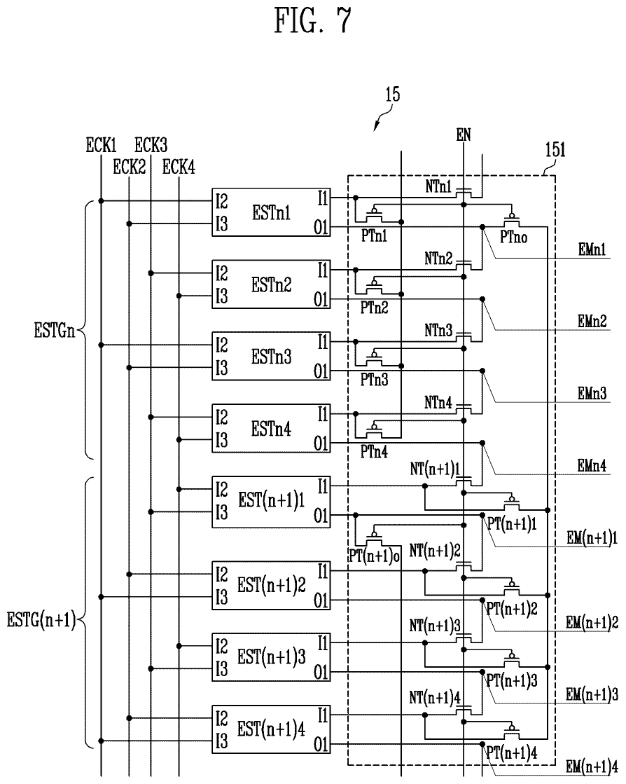

FIG. 7 is a schematic diagram illustrating a light emitting driver according to an embodiment of the present disclosure.

Referring to FIG. 7, the light emitting driver 15 according to an embodiment of the present disclosure may include a plurality of light emitting stages ( . . . , ESTn1, ESTn2, ESTn3, ESTn4, EST (n+1) 1, EST (n+) 1) 2, EST (n+1) 3, EST (n+1) 4, . . . ) and a light emitting stage connection circuit 151. The light emitting driver 15 may be connected to the first light emitting clock line ECK1, the second light emitting clock line ECK2, the third light emitting clock line ECK3, and the fourth light emitting clock line ECK4.

Each of the light emitting stages ESTn1 to EST (n+1) 4 may include a first input terminal 11, a second input terminal 12, a third input terminal 13, and an output terminal 01. The first input terminal I1 may receive the light emitting signal at the turn-off level output from another light emitting stage. However, the first light emitting stage (not shown) of the light emitting driver 15 may receive a light emitting stop signal, which is a turn-off level pulse type, from the timing controller 11 through the first input terminal I1. The second input terminal 12 may be connected to one of the first to fourth light emitting clock lines ECK1 to ECK4. The third input terminal 13 may be connected to another one of the first to fourth light emitting clock lines ECK1 to ECK4. The output terminal 01 may output the light emitting signal at the turn-off level. The output terminal 01 may be connected to the corresponding light emitting line. For instance, FIG. 7 shows the output terminal 01 of the light emitting stages ESTn1 connected to the corresponding light emitting line EMn1. The other output terminals 01 of light emitting stages ESTn2, ESTn3, . . . may also be connected to corresponding light emitting lines EMn2, EMn3, . . .

According to an embodiment, two light emitting stages adjacent to each other may be connected to different light emitting clock lines. For example, the light emitting stage ESTn2 may be connected to the third light emitting clock line ECK3 and the fourth light emitting clock line ECK4, and the light emitting stage ESTn1 or ESTn3 adjacent to the light emitting stage ESTn2 may be connected to the first light emitting clock line ECK1 and the second light emitting clock line ECK2.

m light emitting stages may belong to one light emitting stage group. m may be an integer greater than 1. m may be a multiple of 2. For example, when m is 2, the n-th light emitting stage group ESTGn may include two light emitting stages ESTn1 and ESTn2. When m is 4, the n-th light emitting stage group ESTGn may further include two light emitting stages ESTn3 and ESTn4. At this time, a connection relationship between the light emitting clock lines ECK1 to ECK4 and the light emitting stages ESTn3 and ESTn4 may be the same as a connection relationship between the light emitting clock lines ECK1 to ECK4 and the light emitting stages ESTn1 and ESTn2. In this way, those skilled in the art may increase m referring to the present embodiment. Hereinafter, the description will be made assuming that m is 4.

The n-th light emitting stage group ESTGn may include four light emitting stages ESTn1, ESTn2, ESTn3, and ESTn4. In addition, the n+1-th light emitting stage group ESTG (n+1) adjacent to the n-th light emitting stage group ESTGn may include four other light emitting stages EST (n+1) 1, EST (n+1) 2), EST (n+1) 3, and EST (n+1) 4.

The structure in which the n+1-th light emitting stage group (ESTG (n+1)) is connected to the light emitting clock lines ECK1 to ECK4 may be mirror symmetrical with a structure in which the n-th light emitting stage group ESTGn is connected to the light emitting clock lines ECK1 to ECK4.

For example, the m-1-th light emitting stage ESTn3 of the n-th light emitting stage group ESTGn may have the second input terminal 12 connected to the first light emitting clock line ECK1 and the third input terminal 13 connected to the second light emitting clock line ECK2. The m-th light emitting stage ESTn4 of the n-th light emitting stage group ESTGn may have the third light emitting clock line ECK3 connected to the second input terminal 12 and the third input terminal 13 connected to the fourth light emitting clock line ECK4.

At this time, the first light emitting stage EST (n+1) 1 of the n+1-th light emitting stage group ESTG (n+1) may have the second input terminal 12 connected to the fourth light emitting clock line ECK4 and the third input terminal 13 connected to the third light emitting clock line ECK3. The second light emitting stage (EST (n+1) 2) of the n+1-th light emitting stage group ESTG (n+1) may have the second input terminal I2 connected to the second light emitting clock line ECK2 and the third input terminal 13 connected to the first light emitting clock line ECK1.

The light emitting stage connection circuit 151 may include first connection transistors ( . . . . NTn1, NTn2, NTn3, NTn4, NT (n+1) 1, NT (n+1) 2, NT (n+1) 3, NT (n+1) 4, . . . ) and second connection transistors ( . . . . PTno, PTn1, PTn2, PTn3, PTn4, PTn (n+1) o, PT (n+1) 1, PT (n+1) 2, PT (n+1) 3, PT (n+1) 4, . . . ).

The gate electrodes of the first connection transistors NTn1 to NT (n+1) 4 and the gate electrodes of the second connection transistors PTno to PT (n+1) 4 may be commonly connected to the enable line EN. For example, the timing controller 11 may provide an enable signal and a disable signal through the enable line EN. For example, the enable signal may be a polarity signal (high level) that turns on the first connection transistors NTn1 to NT (n+1) 4, which are first conductive type transistors (e.g., N-type transistors). For example, the disable signal may be a signal (low level) of opposite polarity that turns on the second connection transistors PTno to PT (n+1) 4, which are second conductive type transistors (e.g., P-type transistors).

In another embodiment, the first connection transistors NTn1 to NT (n+1) 4 and the second connection transistors PTno to PT (n+1) 4 may be composed of the same conductive type transistors. In this case, the gate electrodes of the first connection transistors NTn1 to NT (n+1) 4 and the second connection transistors PTno to PT (n+1) 4 are connected to different enable lines.

Since the first connection transistors NTn1 to NT (n+1) 4 are turned on when receiving the enable signal, they may connect each of the first input terminals I1 of the light emitting stages ESTn1 to EST (n+1) 4 to the output terminal of the previous light emitting stage group. For example, when receiving the enable signal, the first connection transistor NTn2 is turned on, so the first input terminal I1 of the light emitting stage ESTn2 may be connected to the output terminal 01 of the light emitting stage ESTn1.

Since the second connection transistors PTno to PT (n+1) 4 are turned on when receiving the disable signal, they may connect each of the first input terminals I1 of the light emitting stages ESTn1 to EST (n+1) 4 to the output terminal of the previous light emitting stage group.

For example, when receiving the disable signal, the second connection transistors PTno, PT (n+1) 1, PT (n+1) 2, PT (n+1) 3, and PT (n+1) 4 are turned on, so the first input terminal I1 of the light emitting stages EST (n+1) 1 to EST (n+1) 4 may be connected to the output terminal 01 of the previous light emitting stage group ESTGn. Here, the output terminal 01 of the previous light emitting stage group ESTGn may be set as the output terminal 01 of the first light emitting stage ESTn1. In another embodiment, the output terminal 01 of the previous light emitting stage group ESTGn may be set as the output terminal 01 of at least one of the light emitting stages ESTn1, ESTn2, ESTn3, and ESTn4.

Similarly, when receiving the disable signal, the second connection transistors PTn1, PTn2, PTn3, and PTn4 are turned on, so the first input terminal I1 of the light emitting stages ESTn1 to ESTn4 may be connected to the output terminal of the previous light emitting stage group (i.e., the n−1-th light emitting stage group (not shown)).

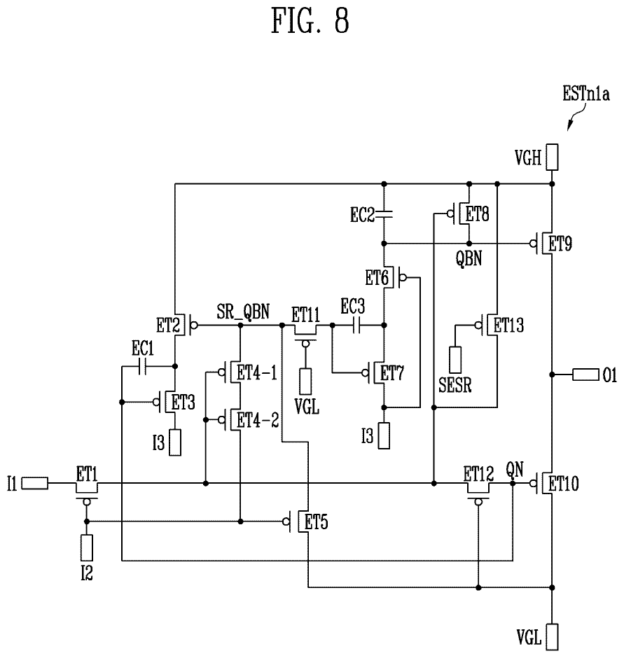

FIG. 8 is a schematic diagram illustrating a light emitting stage, ESTn1a, according to an embodiment of the present disclosure. The light emitting stage ESTn1a may be an example of any of light emitting states EST of FIG. 7, and may include first to thirteenth transistors ET1 to ET13 and capacitors EC1 to EC3.

The first transistor ET1 may have a first electrode connected to the first input terminal 11, a second electrode connected to a first electrode of the twelfth transistor ET12, and a gate electrode connected to the second input terminal I2.

The second transistor ET2 may have a first electrode receiving the first voltage VGH, a second electrode connected to a first electrode of the third transistor ET3, and a gate electrode connected to the node SR_QBN.

The third transistor ET3 may have a first electrode connected to a second electrode of the second transistor ET2, a second electrode connected to the third input terminal 13, and a gate electrode connected to the node QN.

The first capacitor EC1 may have a first electrode connected to a first electrode of the third transistor ET3 and a second electrode connected to a gate electrode of the third transistor ET3.

The fourth transistor may have a first electrode connected to the node SR_QBN, a second electrode connected to the second input terminal 12, and a gate electrode connected to a second electrode of the first transistor ET1. The fourth transistor may include sub-transistors ET4-1 and ET4-2.

The fifth transistor ET5 may have a first electrode connected to the node SR_QBN, a second electrode receiving the second voltage VGL, and a gate electrode connected to the second input terminal 12. A voltage level of the second voltage VGL may be lower than a voltage level of the first voltage VGH.

The sixth transistor ET6 may have a first electrode connected to the node QBN, a second electrode connected to a first electrode of the seventh transistor ET7, and a gate electrode connected to the third input terminal I3.

The second capacitor EC2 may have a first electrode receiving the first voltage VGH and a second electrode connected to the node QBN.

The seventh transistor ET7 may have a first electrode connected to a second electrode of the sixth transistor ET6, a second electrode connected to the third input terminal 13, and a gate electrode connected to a second electrode of the eleventh transistor ET11.

The third capacitor EC3 may have a first electrode connected to a gate electrode of the seventh transistor ET7 and a second electrode connected to a first electrode of the seventh transistor ET7.

The eighth transistor ET8 may have a first electrode receiving the first voltage VGH, a second electrode connected to the node QBN, and a gate electrode connected to a second electrode of the first transistor ET1.

The ninth transistor ET9 may have a first electrode receiving the first voltage VGH, a second electrode connected to the output terminal 01, and a gate electrode connected to the node QBN.

The tenth transistor ET10 may have a first electrode connected to the output terminal 01, a second electrode receiving the second voltage VGL, and a gate electrode connected to the node QN.

The eleventh transistor ET11 may have a first electrode connected to the node SR_QBN, a second electrode connected to a gate electrode of the seventh transistor ET7, and a gate electrode receiving the second voltage VGL.

The twelfth transistor ET12 may have a first electrode connected to the second electrode of the first transistor ET1, a second electrode connected to the node QN, and a gate electrode receiving the second voltage VGL.

The thirteenth transistor ET13 may have a first electrode receiving the first voltage VGH, a second electrode connected to the node QN, and a gate electrode connected to the reset terminal SESR. In an alternative embodiment, the thirteenth transistor ET13 may be omitted.

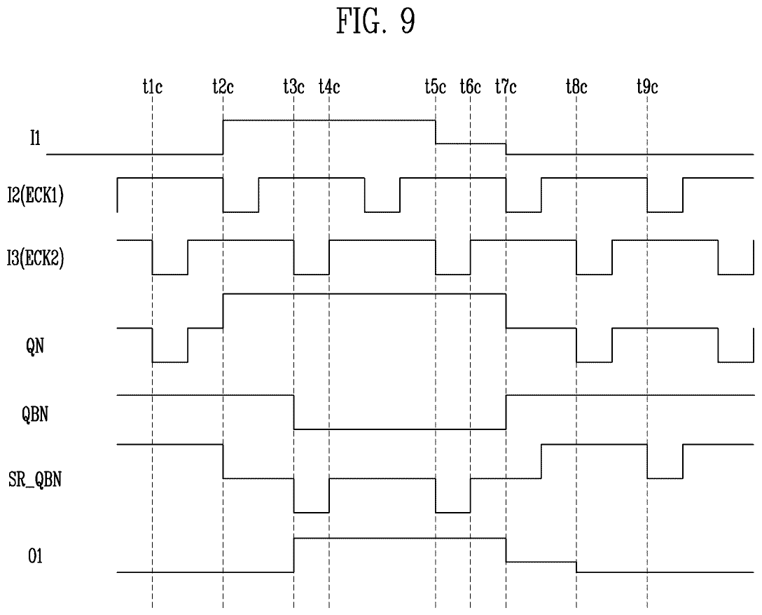

FIG. 9 is a signal/timing diagram illustrating a driving method of the light emitting stage of FIG. 8.

In FIG. 9, “I3 (ECK2)” denotes the second light emitting clock line ECK2 connected to the third input terminal 13. At time tic, the second light emitting clock signal at this line may have transitioned from a high level to a low level. The node QN may be coupled to the third input terminal 13 through the third transistor ET3 and the first capacitor EC1, which are turned on. Accordingly, a voltage level of the node QN may decrease.

“I2 (ECK1)” denotes the first light emitting clock line ECK1 connected to the second input terminal 12. At time t2c, the first light emitting clock signal at this line may have transitioned to a low level. Accordingly, the first transistor ET1 may be turned on, and the light emitting signal at the turn-off level (high level) of the previous light emitting stage input through the first input terminal I1 may be applied to the node QN. The twelfth transistor ET12 may be turned on. Meanwhile, the second voltage VGL may be applied to the node SR_QBN through the turned-on fifth transistor ET5. Accordingly, the second transistor ET2 and the seventh transistor ET7 may be turned on.

At time t3c, the second light emitting clock signal of the third input terminal 13 may have again transitioned to a low level. The node SR_QBN may be coupled to the third input terminal 13 through the eleventh transistor ET11 in the turn-on state, the third capacitor EC3, and the seventh transistor ET7 in the turn-on state. Accordingly, a voltage level of the node SR_QBN may decrease. Additionally, a voltage level of the node QBN may decrease through the sixth transistor ET6 that is turned on. Accordingly, the ninth transistor ET9 may be turned on, and the first voltage VGH may be output to the output node 01 as a light emitting signal at the turn-off level (high level).

At time t4c, the second light emitting clock signal of the third input terminal 13 may have transitioned to a high level. Accordingly, the sixth transistor ET6 may be turned off. At this time, since the node QBN maintains a voltage at a low level by the second capacitor EC2, the ninth transistor ET9 may maintain the turn-on state.

At time t5c, the light emitting stage ESTn1a may operate the same way as at time t3c. At time t6c, the light emitting stage ESTn1a may operate the same way as at time t4c.

At time t7c, the first light emitting clock signal of the second input terminal 12 may have transitioned to a low level. Accordingly, the first transistor ET1 may be turned on, and the light emitting signal at the turn-on level (low level) of the previous light emitting stage input through the first input terminal I1 may be applied to the node QN. Accordingly, the tenth transistor ET10 may be turned on, and the second voltage VGL may be output to the output node 01 as a light emitting signal at the turn-on level (low level). At this time, the node QBN may receive the first voltage VGH through the turned-on eighth transistor ET8. Accordingly, the ninth transistor ET9 may be turned off.

At time t8c, the light emitting stage ESTna may operate the same way as at time t1c. At time t9c, the light emitting stage ESTn1a may operate the same way as at time t7c.

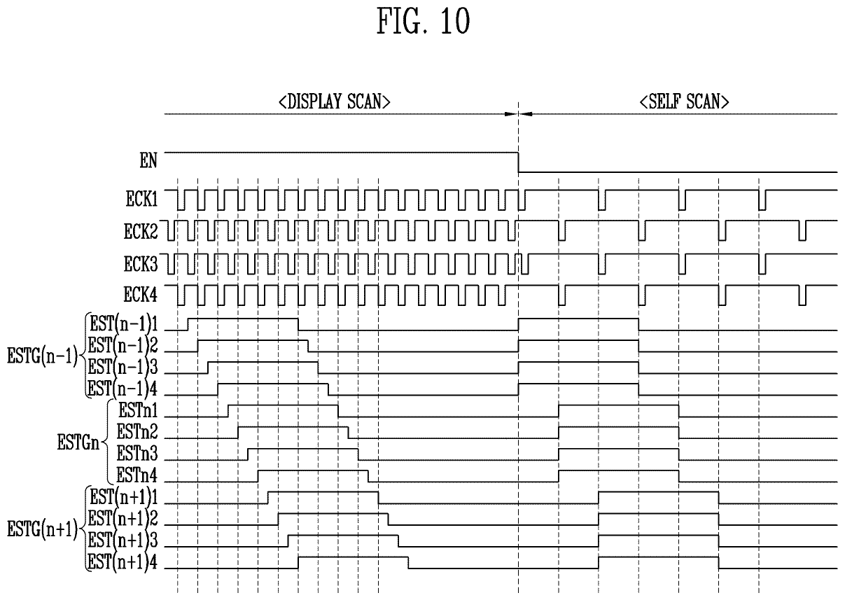

FIG. 10 is a signal/timing diagram illustrating a driving method of a light emitting driver composed of light emitting stages of FIG. 8. In FIG. 10, the levels associated with the stages EST (n-1) 1 to EST (n+1) 4 may be the voltages at the 01 terminals of the respective stages.

According to an embodiment of the present disclosure, as shown in FIG. 10, during the first scan period DISPLAY SCAN, the first light emitting clock signal applied to the first light emitting clock line ECK1 may be the same as the fourth light emitting clock signal applied to the fourth light emitting clock line ECK4. Thus, during the first scan period DISPLAY SCAN, the frequency and phase of the first light emitting clock signal may be the same as the frequency and phase of the fourth light emitting clock signal.

Additionally, during the first scan period DISPLAY SCAN, the second light emitting clock signal applied to the second light emitting clock line ECK2 may be the same as the third light emitting clock signal applied to the third light emitting clock line ECK3. Thus, during the first scan period DISPLAY SCAN, the frequency and phase of the second light emitting clock signal may be the same as the frequency and phase of the third light emitting clock signal.

However, during the second scan period SELF SCAN, the first light emitting clock signal may be the same as the third light emitting clock signal, and the second light emitting clock signal may be the same as the fourth light emitting clock signal. Hence, during the second scan period SELF SCAN, the frequency and phase of the first light emitting clock signal may be the same as the frequency and phase of the third light emitting clock signal, and the frequency and phase of the second light emitting clock signal may be the same as the frequency and phase of the fourth light emitting clock signal.

The light emitting stage connection circuit 151 may receive an enable signal during the first scan period DISPLAY SCAN and a disable signal during the second scan period SELF SCAN. As described above, a high level signal applied to the enable line EN (and to gates of N-type transistors) may be an enable signal, and a low level signal applied to the enable line EN may be a disable signal.

When receiving an enable signal, the light emitting stage connection circuit 151 may connect each of the first input terminals I1 of the light emitting stages ( . . . , EST (n-1) 1, EST (n-1) 2, EST (n-1) 3, EST (n-1) 4, ESTn1, ESTn2, ESTn3, ESTn4, ESTn1, EST (n+1) 1, EST (n+1) 2, EST (n+1) 3, EST (n+1) 4, . . . ) to the output terminal of the previous light emitting stage. Accordingly, during the first scan period DISPLAY SCAN, the light emitting stages ( . . . , EST (n-1) 1 to EST (n+1) 4, . . . ) may sequentially generate the light emitting signals at the turn-off level in units of one light emitting stage.

Meanwhile, when receiving a disable signal, the light emitting stage connection circuit 151 may connect each of the first input terminals I1 of the light emitting stages ( . . . , EST (n-1) 1 to EST (n+1) 4, . . . ) to the output terminal of the previous light emitting stage group. Accordingly, during the second scan period SELF SCAN, the light emitting stages ( . . . , EST (n-1) 1 to EST (n+1) 4, . . . ) may sequentially generate the light emitting signals at the turn-off level in units of m light emitting stages. In FIG. 10, m is 4, and four light emitting stages may constitute each light emitting stage group ( . . . , ESTG (n-1), ESTGn, ESTG (n+1), . . . ). Consequently, during the second scan period SELF SCAN, the light emitting stage groups ( . . . , ESTG (n-1), ESTGn, ESTG (n+1), . . . ) may sequentially generate the light emitting signals at the turn-off level in units of 4 light emitting stages.

The frequency of the light emitting clock signals applied to the light emitting clock lines ECK1, ECK2, ECK3, and ECK4 during the first scan period DISPLAY SCAN may be m times the frequency of the light emitting clock signals applied to the light emitting clock lines ECK1, ECK2, ECK3, and ECK4 during the second scan period SELF SCAN. Accordingly, the length of the light emitting signal at the turn-off level during the first scan period DISPLAY SCAN may be the same as the length of the light emitting signal at the turn-off level during the second scan period SELF SCAN.

Referring still to FIG. 10, it may be seen that a cycle of the light emitting clock signals during the second scan period SELF SCAN is longer than a cycle of the light emitting clock signals during the first scan period DISPLAY SCAN. For example, when m is 4, the cycle of the light emitting clock signals during the second scan period SELF SCAN may be 4 times the cycle of the light emitting clock signals during the first scan period DISPLAY SCAN. Therefore, according to this embodiment, power consumption while generating light emitting clock signals may be reduced during the second scan period SELF SCAN.

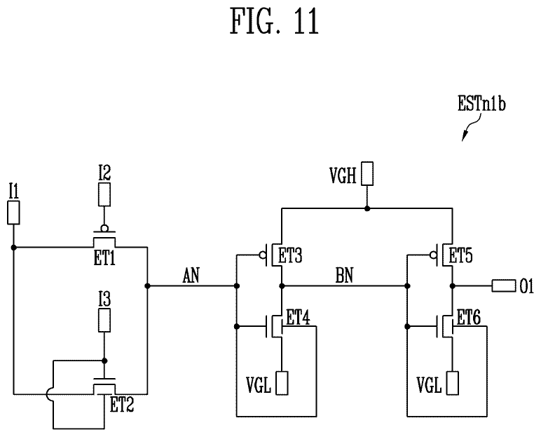

FIG. 11 is a schematic diagram illustrating a light emitting stage, ESTn1b, according to another embodiment of the present disclosure. The light emitting stage ESTn1b may include transistors ET1, ET2, ET3, ET4, ET5, and ET6. The transistors ET1, ET3, and ET5 may be P-type transistors. The transistors ET2, ET4, and ET6 may be N-type transistors having a sub-gate (or back-gate) electrode. The light emitting stage ESTn1b is another example of any of the light emitting stages EST of FIG. 7.

The first transistor ET1 may have a first electrode connected to the first input terminal 11, a second electrode connected to the node AN, and a gate electrode connected to the second input terminal I2.

The second transistor ET2 may have a first electrode connected to the first input terminal 11, a second electrode connected to the node AN, and a gate electrode connected to the third input terminal 13. The sub-gate electrode of the second transistor ET2 may be connected to the third input terminal I3.

The third transistor ET3 may have a first electrode receiving the first voltage VGH, a second electrode connected to the node BN, and a gate electrode connected to the node AN.

The fourth transistor ET4 may have a first electrode connected to the node BN, a second electrode receiving the second voltage VGL, and a gate electrode connected to the node AN. The sub-gate electrode of the fourth transistor ET4 may be connected to the node AN.

The fifth transistor ET5 may have a first electrode receiving the first voltage VGH, a second electrode connected to the output terminal 01, and a gate electrode connected to the node BN.

The sixth transistor ET6 may have a first electrode connected to the output terminal 01, a second electrode receiving the second voltage VGL, and a gate electrode connected to the node BN. The sub-gate electrode of the sixth transistor ET6 may be connected to the node BN.

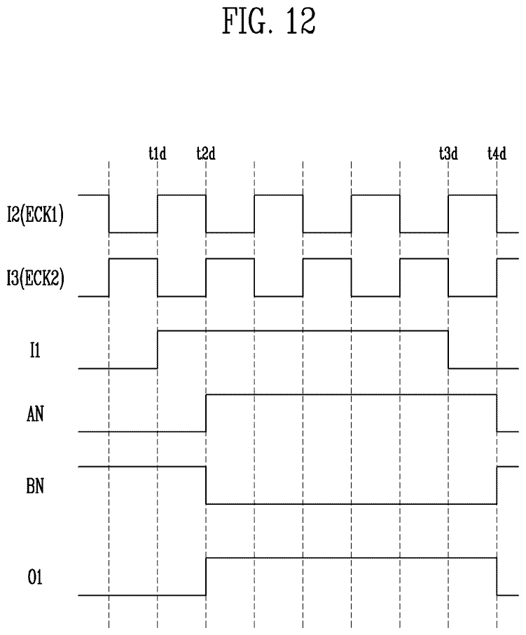

FIG. 12 is a signal/timing diagram illustrating a driving method of a light emitting stage of FIG. 11.

At time t1d, the first light emitting clock signal applied to the first light emitting clock line ECK1 connected to the second input terminal 12 may have transitioned from a low level to a high level. Accordingly, the first transistor ET1 may be turned off. Additionally, the second light emitting clock signal applied to the second light emitting clock line ECK2 connected to the third input terminal 13 may have transitioned from a high level to a low level. Accordingly, the second transistor ET2 may be turned off.

At this time, the light emitting signal at the turn-off level (high level) output from the previous light emitting stage may be applied to the first input terminal 11, but a voltage of the node AN may be maintained by the first and second transistors ET1 and ET2, which are in the turn-off state.

At time t2d, the first light emitting clock signal of the second input terminal 12 may have transitioned to a low level. Accordingly, the first transistor ET1 may be turned on. Additionally, the second light emitting clock signal of the third input terminal 13 may have transitioned to a high level. Accordingly, the second transistor ET2 may be turned on.

At this time, the voltage of the node AN may have increased to a high level through the turned-on first and second transistors ET1 and ET2. Accordingly, the fourth transistor ET4 may be turned on, and the node BN may receive the second voltage VGL and the voltage level may decrease.

When the voltage level of the node BN becomes a low level, the fifth transistor ET5 may be turned on. Accordingly, the first voltage VGH may be applied to the output terminal 01 as an output signal of the light emitting stage ESTn1b. Accordingly, the light emitting stage ESTn1b may output the light emitting signal at the turn-off level.

At time t3d, the first light emitting clock signal of the second input terminal 12 may have transitioned to a high level. Accordingly, the first transistor ET1 may be turned off. Additionally, the second light emitting clock signal of the third input terminal 13 may have transitioned to a low level. Accordingly, the second transistor ET2 may be turned off.

At this time, the light emitting signal at the turn-on level (low level) output from the previous light emitting stage may be applied to the first input terminal I1, but the voltage of the node AN may be maintained by the first and second transistors ET1 and ET2, which are in the turn-off state.

At time t4d, the first light emitting clock signal of the second input terminal 12 may have transitioned to a low level. Accordingly, the first transistor ET1 may be turned on. Additionally, the second light emitting clock signal of the third input terminal 13 may transition to a high level. Accordingly, the second transistor ET2 may be turned on.

At this time, the voltage of the node AN may transition to a low level through the turned-on first and second transistors ET1 and ET2. Accordingly, the third transistor ET3 may be turned on, and the node BN may receive the first voltage VGH and the voltage level may increase.

When the voltage level of the node BN becomes a high level, the sixth transistor ET6 may be turned on. Accordingly, the second voltage VGL may be applied to the output terminal 01 as an output signal of the light emitting stage ESTn1b. Accordingly, the light emitting stage ESTn1b may output the light emitting signal at the turn-on level.

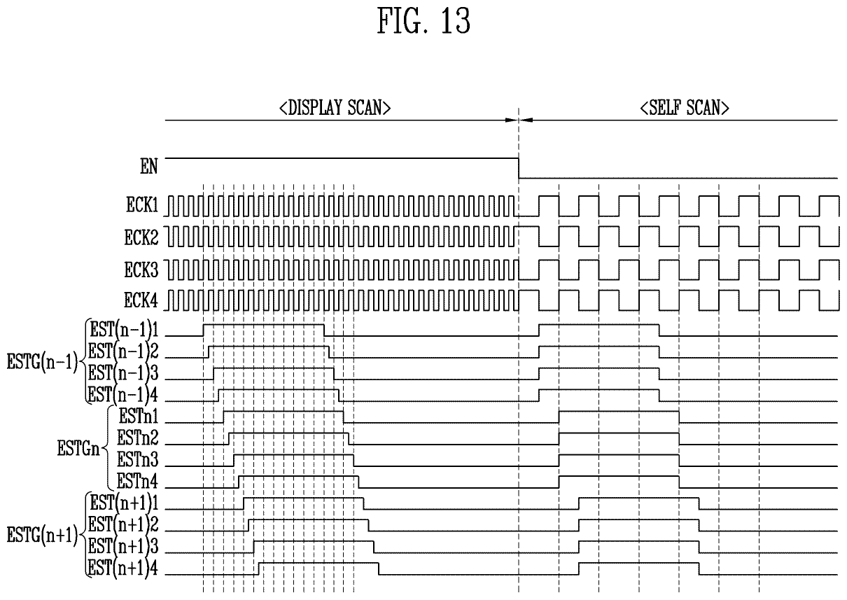

FIG. 13 is a signal/timing diagram illustrating a driving method of a light emitting driver composed of light emitting stages of FIG. 11. In FIG. 13, the levels associated with the stages EST (n-1) 1 to EST (n+1) 4 may be the voltages at the 01 terminals of the respective stages.

It is seen in FIG. 13 that the waveforms are similar to those of FIG. 10, except a higher number of ECK pulses are exemplified for each corresponding EST pulse during each of the DISPLAY SCAN and SELF SCAN, and the on/off cycles of the ECK pulses during the SELF SCAN are more uniform. Otherwise, the description of FIG. 10 may be applied equally to FIG. 13, and therefore duplicate description is omitted.

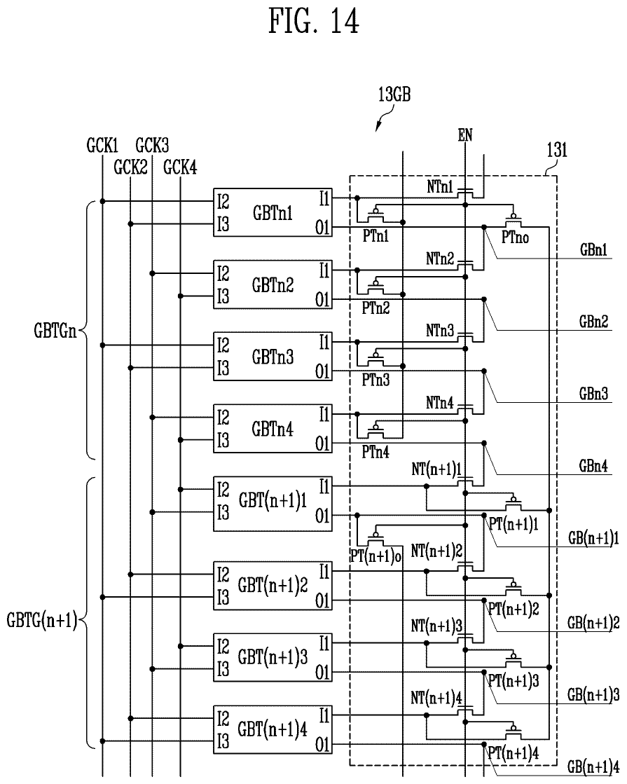

FIG. 14 is a schematic diagram illustrating a second scan driver 13B according to an embodiment of the present disclosure.

The second scan driver 13 GB of FIG. 14 is an example of the scan driver 13B of FIG. 1, which is a part of the scan driver 13 providing scan signals to scan lines GB1 to GBp. The second scan driver 13GBmay include a plurality of scan stages ( . . . , GBTn1, GBTn2, GBTn3, GBTn4, GBT (n+1) 1, GBT (n+1) 2, GBT (n+1) 3, GBT (n+1) 4, . . . ) and a scan stage connection circuit 131. The second scan driver 13 GB may be connected to a first scan clock line GCK1, a second scan clock line GCK2, a third scan clock line GCK3, and a fourth scan clock line GCK4.

Each of the scan stages GBTn1 to GBT (n+1) 4 may include a first input terminal I1, a second input terminal 12, a third input terminal 13, and an output terminal 01. The first input terminal I1 may receive the second scan signal at the turn-on level output from another scan stage. However, the first scan stage (not shown) of the second scan driver 13 GB may receive a scan start signal, which is a pulse having a turn-on level, from the timing controller 11 through the first input terminal I1. The second input terminal 12 may be connected to one of the first to fourth scan clock lines GCK1 to GCK4. The third input terminal 13 may be connected to another one of the first to fourth scan clock lines GCK1 to GCK4. The output terminal 01 may output the second scan signal at the turn-on level. The output terminal 01 may be connected to the corresponding second scan line GB. For instance, FIG. 14 shows the output terminal 01 of the scan stage GBTn1 connected to the corresponding second scan line GBn1. The other output terminals 01 of scan stages GBTn2, GBTn3, . . . may also be connected to corresponding second scan lines GBn2, GBn3, . . .

According to an embodiment, two scan stages adjacent to each other may be connected to different scan clock lines. For example, the scan stage GBTn2 may be connected to the third scan clock line GCK3 and the fourth scan clock line GCK4, and the scan stage GBTn1 or GBTn3 adjacent to the scan stage GBTn2 may be connected to the first scan clock line GCK1 and the second scan clock line GCK2.

m scan stages may belong to one scan stage group. m may be an integer greater than 1. m may be a multiple of 2. For example, when m is 2, the n-th scan stage group GBTGn may include two scan stages GBTn1 and GBTn2. When m is 4, as in the example illustrated in FIG. 14, the n-th scan stage group GBTGn may further include two scan stages GBTn3 and GBTn4. In this case, a connection relationship between the scan clock lines GCK1 to GCK4 and the scan stages GBTn3 and GBTn4 may be the same as a connection relationship between the scan clock lines GCK1 to GCK4 and the scan stages GBTn1 and GBTn2. If the number of scan stages GBT per scan stage group GBTG is increased further in units of 2 (i.e., m is increased further in units of 2), the same connection relationship with the scan clock lines may be made with respect to the additional scan stages. Hereinafter, the description will be made assuming that m is 4.

The n-th scan stage group GBTGn may include four scan stages GBTn1, GBTn2, GBTn3, and GBTn4. In addition, the n+1-th scan stage group GBTG (n+1) adjacent to the n-th scan stage group GBTGn may have four other scan stages GBT (n+1) 1, GBT (n+1) 2), GBT (n+1) 3, and GBT (n+1) 4.

A structure in which the n+1-th scan stage group GBTG (n+1) is connected to scan clock lines GCK1 to GCK4 may be mirror symmetrical with a structure in which the n-th scan stage group GBTGn is connected to scan clock lines GCK1 to GCK4.

For example, the m-1-th scan stage GBTn3 of the n-th scan stage group GBTGn may have a second input terminal 12 connected to the first scan clock line GCK1 and a third input terminal 13 connected to the second scan clock line GCK2. The m-th scan stage GBTn4 of the n-th scan stage group GBTGn may have a second input terminal 12 connected to the third scan clock line GCK3 and a third input terminal 13 connected to the fourth scan clock line GCK4.

Now, the first scan stage GBT (n+1) 1 of the n+1-th scan stage group GBTG (n+1) may have a second input terminal 12 connected to the fourth scan clock line GCK4 and a third input terminal 13 connected to the third scan clock line GCK3. The second scan stage GBT (n+1) 2 of the n+1-th scan stage group GBTG (n+1) may have a second input terminal 12 connected to the second scan clock line GCK2 and a third input terminal 13 connected to the first scan clock line GCK1.

The scan stage connection circuit 131 may include first connection transistors ( . . . . NTn1, NTn2, NTn3, NTn4, NT (n+1) 1, NT (n+1) 2, NT (n+1) 3, NT (n+1) 4, . . . ) and second connection transistors ( . . . . PTno, PTn1, PTn2, PTn3, PTn4, PTn (n+1) o, PT (n+1) 1, PT (n+1) 2, PT (n+1) 3, PT (n+1) 4, . . . ).

The gate electrodes of the first connection transistors NTn1 to NT (n+1) 4 and the gate electrodes of the second connection transistors PTno to PT (n+1) 4 may be commonly connected to the enable line EN. For example, the timing controller 11 may provide an enable signal and a disable signal through the enable line EN. For example, the enable signal may be a gate biasing signal (high level) that turns on the first connection transistors NTn1 to NT (n+1) 4, which are first conductive type transistors (e.g., N-type transistors). For example, the disable signal may be a gate biasing signal (low level) of opposite polarity that turns on the second connection transistors PTno to PT (n+1) 4, which are second conductive type transistors (e.g., P-type transistors).

In another embodiment, the first connection transistors NTn1 to NT (n+1) 4 and the second connection transistors PTno to PT (n+1) 4 may be composed of the same conductive type transistors. In this case, the gate electrodes of the first connection transistors NTn1 to NT (n+1) 4 and the second connection transistors PTno to PT (n+1) 4 are connected to different enable lines.

The first connection transistors NTn1 to NT (n+1) 4 may be turned on when receiving an enable signal, and they may connect each of the first input terminals I1 of the scan stages GBTn1 to GBT (n+1) 4 to the output terminal of the previous scan stage. For example, when receiving the enable signal, the first connection transistor NTn2 may be turned on, so the first input terminal I1 of the scan stage GBTn2 may be connected to the output terminal 01 of the scan stage GBTn1.

The second connection transistors PTno to PT (n+1) 4 may be turned on when receiving a disable signal, and they may connect each of the first input terminals I1 of the scan stages GBTn1 to GBT (n+1) 4 to the output terminal of the previous scan stage group.

For example, when receiving the disable signal, the second connection transistors PTno, PT (n+1) 1, PT (n+1) 2, PT (n+1) 3, and PT (n+1) 4 may be turned on, so the first input terminal I1 of the scan stages GBT (n+1) 1 to GBT (n+1) 4 may be connected to the output terminal 01 of the previous scan stage group GBTGn. Here, the output terminal 01 of the previous scan stage group GBTGn may be set to the output terminal 01 of the first scan stage GBTn1. In another embodiment, the output terminal 01 of the previous scan stage group GBTGn may be set as the output terminal 01 of at least one of the scan stages GBTn1, GBTn2, GBTn3, and GBTn4.

Similarly, when receiving the disable signal, the second connection transistors PTn1, PTn2, PTn3, and PTn4 may be turned on, so the first input terminal I1 of the scan stages GBTn1 to GBTn4 may be connected to the output terminal of the previous scan stage group (i.e., the n-1-th scan stage group (not shown)).

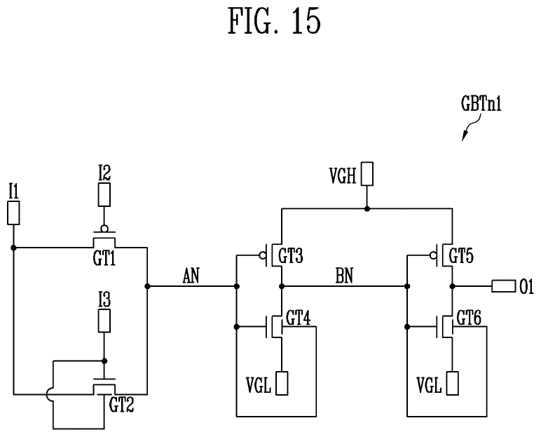

FIG. 15 is a schematic diagram illustrating a scan stage according to an embodiment of the present disclosure.

Referring to FIG. 15, the scan stage GBTn1 according to an embodiment of the present disclosure may include transistors GT1, GT2, GT3, GT4, GT5, and GT6. The transistors GT1, GT3, and GT5 may be P-type transistors. The transistors GT2, GT4, and GT6 may be N-type transistors.

The first transistor GT1 may have a first electrode connected to the first input terminal I1, a second electrode connected to the node AN, and a gate electrode connected to the second input terminal I2.

The second transistor GT2 may have a first electrode connected to the first input terminal 11, a second electrode connected to the node AN, and a gate electrode connected to the third input terminal I3. According to the embodiment, the sub-gate electrode (or back gate electrode) of the second transistor GT2 may be connected to the third input terminal I3.

The third transistor GT3 may have a first electrode receiving the first voltage VGH, a second electrode connected to the node BN, and a gate electrode connected to the node AN.

The fourth transistor GT4 may have a first electrode connected to the node BN, a second electrode receiving the second voltage VGL, and a gate electrode connected to the node AN. According to the embodiment, the sub-gate electrode (or back gate electrode) of the fourth transistor GT4 may be connected to the node AN.

The fifth transistor GT5 may have a first electrode receiving the first voltage VGH, a second electrode connected to the output terminal 01, and a gate electrode connected to the node BN.

The sixth transistor GT6 may have a first electrode connected to the output terminal 01, a second electrode receiving the second voltage VGL, and a gate electrode connected to the node BN. The sub-gate electrode (or back gate electrode) of the sixth transistor GT6 may be connected to the node BN.

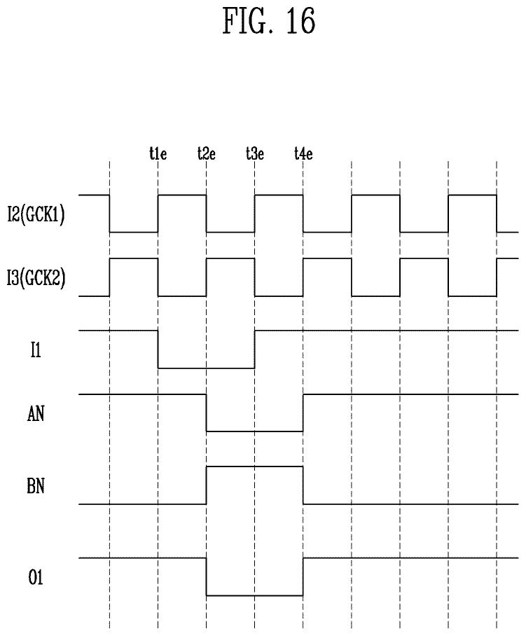

FIG. 16 is a signal/timing diagram illustrating a driving method of a scan stage of FIG. 15.

At time tle, the first scan clock signal applied to the first scan clock line GCK1 connected to the second input terminal 12 may have transitioned to a high level. Accordingly, the first transistor GT1 may be turned off. Additionally, the second scan clock signal applied to the second scan clock line GCK2 connected to the third input terminal 13 may have transitioned to a low level. Accordingly, the second transistor GT2 may be turned off.

At this time, the second scan signal at the turn-on level (low level) output from the previous scan stage may be applied to the first input terminal I1, but the voltage of the node AN may be maintained by the first and second transistors GT1 and GT2.

At time t2e, the first scan clock signal of the second input terminal 12 may have decreased to a low level. Accordingly, the first transistor GT1 may be turned on. Additionally, the second scan clock signal of the third input terminal 13 may have increased to a high level. Accordingly, the second transistor GT2 may be turned on.

At this time, the voltage of the node AN may be decreased to a low level through the turned-on first and second transistors GT1 and GT2. Accordingly, the third transistor GT3 may be turned on, and the node BN may receive the first voltage VGH and the voltage level may increase.

When the voltage level of the node BN becomes a high level, the sixth transistor GT6 may be turned on. Accordingly, the second voltage VGL may be applied to the output terminal 01 as an output signal of the scan stage GBTn1. Accordingly, the scan stage GBTn1 may output the second scan signal at the turn-on level (low level).

At time t3e, the first scan clock signal of the second input terminal 12 may have transitioned to a high level. Accordingly, the first transistor GT1 may be turned off. Additionally, the second scan clock signal of the third input terminal 13 may be decreased to a low level. Accordingly, the second transistor GT2 may be turned off.

At this time, the second scan signal of the turn-off level (high level) output from the previous scan stage may be applied to the first input terminal I1, but the voltage of the node AN may be maintained by the first and second transistors GT1 and GT2.

At time t4e, the first scan clock signal of the second input terminal 12 may have transitioned to a low level. Accordingly, the first transistor GT1 may be turned on. Additionally, the second scan clock signal of the third input terminal 13 may be increased to a high level. Accordingly, the second transistor GT2 may be turned on.

At this time, the voltage of the node AN may be increased to a high level through the turned-on first and second transistors GT1 and GT2. Accordingly, the fourth transistor GT4 may be turned on, and the node BN may receive the second voltage VGL and the voltage level may decrease.

When the voltage level of the node BN becomes a low level, the fifth transistor GT5 may be turned on. Accordingly, the first voltage VGH may be applied to the output terminal 01 as an output signal of the scan stage GBTn1. Accordingly, the scan stage GBTn1 may output the second scan signal at the turn-off level (high level).

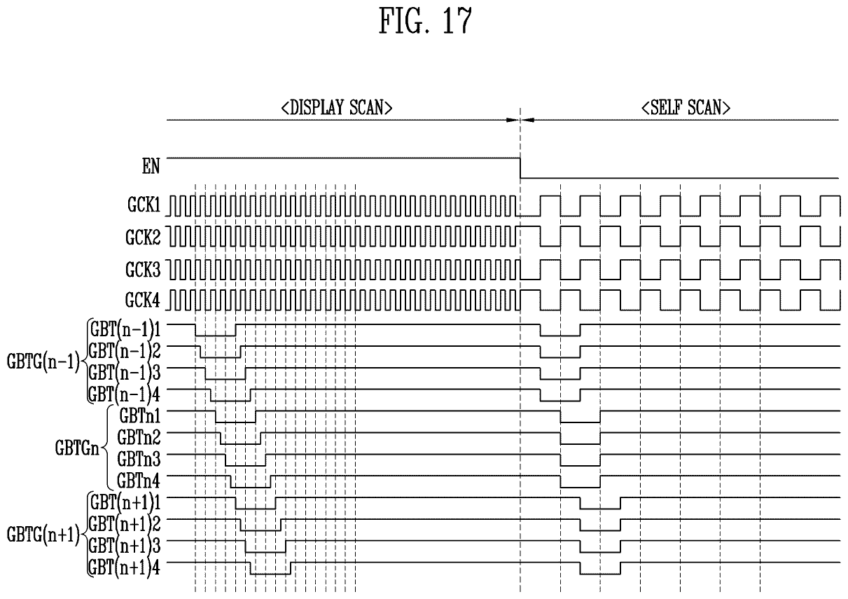

FIG. 17 is a signal/timing diagram illustrating a driving method of a second scan driver composed of scan stages of FIG. 15. In FIG. 17, the levels associated with the stages GBT (n-1) 1 to GBT (n+1) 4 may be the voltages at the 01 terminals of the respective stages.

According to an embodiment of the present disclosure, during the first scan period DISPLAY SCAN, the first scan clock signal applied to the first scan clock line GCK1 may be the same as the fourth scan clock signal applied to the fourth scan clock line GCK4. Thus, during the first scan period DISPLAY SCAN, the frequency and phase of the first scan clock signal may be the same as the frequency and phase of the fourth scan clock signal.

Additionally, during the first scan period DISPLAY SCAN, the second scan clock signal applied to the second scan clock line ECK2 may be the same as the third scan clock signal applied to the third scan clock line GCK3. Thus, during the first scan period DISPLAY SCAN, the frequency and phase of the second scan clock signal may be the same as the frequency and phase of the third scan clock signal.

However, during the second scan period SELF SCAN, the first scan clock signal may be the same as the third scan clock signal, and the second scan clock signal may be the same as the fourth scan clock signal. Hence, during the second scan period SELF SCAN, the frequency and phase of the first scan clock signal may be the same as the frequency and phase of the third scan clock signal, and the frequency and phase of the second scan clock signal may be the same as the frequency and phase of the fourth scan clock signal.

The scan stage connection circuit 131 may receive an enable signal during the first scan period DISPLAY SCAN and a disable signal during the second scan period SELF SCAN. As described above, a high level signal applied to the enable line EN may be an enable signal, and a low level signal applied to the enable line EN may be a disable signal.

When receiving an enable signal, the scan stage connection circuit 131 may connect each of the first input terminals I1 of the scan stages ( . . . , GBT (n-1) 1, GBT (n-1) 2, GBT (n-1) 3, GBT (n-1) 4, GBTn1, GBTn2, GBTn3, GBTn4, GBTn1, GBT (n+1) 1, GBT (n+1) 2, GBT (n+1) 3, GBT (n+1) 4, . . . ) to the output terminal of the previous scan stage. Accordingly, during the first scan period DISPLAY SCAN, the scan stages ( . . . , GBT (n-1) 1 to GBT (n+1) 4, . . . ) may sequentially generate second scan signals at the turn-on level (low level) in units of one scan stage.

Meanwhile, when receiving a disable signal, the scan stage connection circuit 131 may connect each of the first input terminals I1 of the scan stages ( . . . , GBT (n-1) 1 to GBT (n+1) 4, . . . ) to the output terminal of the previous scan stage group. Accordingly, during the second scan period SELF SCAN, the scan stages ( . . . , GBT (n-1) 1 to GBT (n+1) 4, . . . ) may sequentially generate second scan signals at the turn-on level (low level) in units of m scan stages. In FIG. 17, m is 4, and four scan stages may constitute each light emitting stage group ( . . . , GBTG (n-1), GBTGn, GBTG (n+1), . . . ). Thus, during the second scan period SELF SCAN, the scan stage groups ( . . . , GBTG (n-1), GBTGn, GBTG (n+1), . . . ) may sequentially generate second scan signals at the turn-on level in units of 4 scan stages.

The frequency of the scan clock signals applied to the scan clock lines GCK1, GCK2, GCK3, and GCK4 during the first scan period DISPLAY SCAN may be m times the frequency of the scan clock signals applied to the scan clock lines GCK1, GCK2, GCK3, and GCK4 during the second scan period SELF SCAN. Therefore, the length of the second scan signal at the turn-on level (the cumulative length of the individual pulses at the turn-on level) during the first scan period DISPLAY SCAN may be the same as the length of the second scan signal at the turn-on level during the second scan period SELF SCAN.

Referring still to FIG. 17, it may be seen that a cycle of scan clock signals during the second scan period SELF SCAN is longer than a cycle of scan clock signals during the first scan period DISPLAY SCAN. For example, when m is 4, the cycle of scan clock signals during the second scan period SELF SCAN may be 4 times the cycle of scan clock signals during the first scan period DISPLAY SCAN. Therefore, according to this embodiment, power consumption when generating scan clock signals may be reduced during the second scan period SELF SCAN.

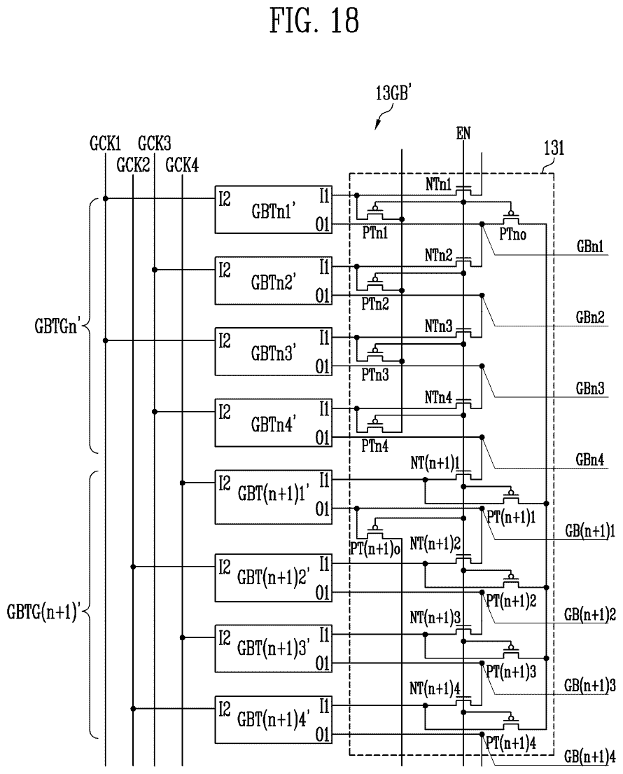

FIG. 18 is a schematic diagram illustrating a second scan driver according to another embodiment of the present disclosure.

The second scan driver 13 GB′ of FIG. 18 may differ from the second scan driver 13 GB of FIG. 14 in that each of the scan stages ( . . . , GBTn1′, GBTn2′, GBTn3′, GBTn4′, GBT (n+1) 1′, GBT (n+1) 2). ‘, GBT (n+1) 3’, GBT (n+1) 4′, . . . ) does not include the third input terminal I3.

Referring to FIG. 18, the second scan driver 13 GB′ according to an embodiment of the present disclosure may include a plurality of scan stages ( . . . , GBTn1′˜GBT (n+1) 4′, . . . ) and a scan stage connection circuit 131. The second scan driver 13 GB′ may be connected to the first scan clock line GCK1, the second scan clock line GCK2, the third scan clock line GCK3, and the fourth scan clock line GCK4.

Each of the scan stages GBTn1′ to GBT (n+1) 4′ may include a first input terminal 11, a second input terminal 12, and an output terminal 01. The first input terminal I1 may receive the second scan signal at the turn-on level output from another scan stage. However, the first scan stage (not shown) of the second scan driver 13 GB′ may receive a scan start signal, which is a turn-on level pulse type, from the timing controller 11 through the first input terminal 11. The second input terminal 12 may be connected to one of the first to fourth scan clock lines GCK1 to GCK4. The output terminal 01 may output the second scan signal at the turn-on level. The output terminal 01 may be connected to the corresponding second scan line GB. For instance, FIG. 18 shows the output terminal 01 of the scan stage GBTn1′ connected to the corresponding second scan line GBn1. The other output terminals 01 of scan stages GBTn2′, GBTn3′, . . . may also be connected to corresponding second scan lines GBn2, GBn3, . . .

According to an embodiment, two scan stages adjacent to each other may be connected to different scan clock lines. For example, the scan stage (GBTn2′) may be connected to the third scan clock line GCK3, and the scan stage (GBTn1′ or GBTn3′) adjacent to the scan stage (GBTn2′) may be connected to the first scan clock line GCK1.

m scan stages may belong to one scan stage group. m may be an integer greater than 1. m may be a multiple of 2. For example, when m is 2, the n-th scan stage group GBTGn′ may include two scan stages GBTn1′ and GBTn2′. When m is 4, the n-th scan stage group GBTGn′ may further include two scan stages GBTn3′ and GBTn4′. Now, a connection relationship between the scan clock lines GCK1 to GCK4 and the scan stages GBTn3′ and GBTn4′ may be the same as a connection relationship between the scan clock lines GCK1 to GCK4 and the scan stages GBTn1′ and GBTn2′. If the number of scan stages GBT′ per scan stage group GBTG′ is increased further in units of 2 (i.e., m is increased further in units of 2), the same connection relationship with the scan clock lines may be made with respect to the additional scan stages. Hereinafter, a description will be made assuming that m is 4.

The n-th scan stage group GBTGn′ may include four scan stages GBTn1′, GBTn2′, GBTn3′, and GBTn4′. In addition, the n+1-th scan stage group GBTG (n+1)′ adjacent to the n-th scan stage group GBTGn′ may include four other scan stages GBT (n+1) 1′, GBT (n+1) 2′, GBT (n+1) 3′, and GBT (n+1) 4′.

The scan stage connection circuit 131 may have the same configuration, and operate the same way, as the scan stage connection circuit 131 shown in FIG. 14 and described above (with GBTn1′ substituted for GBTn1, GBTn2′ substituted for GBTn2, etc.). Accordingly, redundant description of the scan stage connection circuit 131 is omitted.

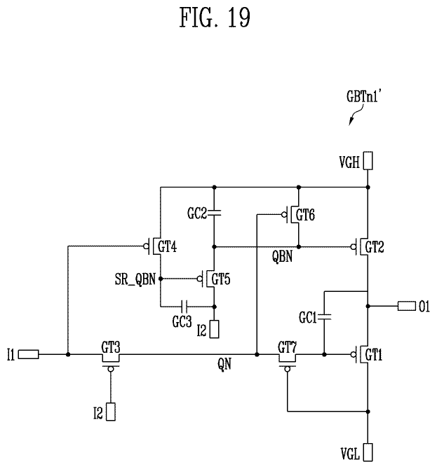

FIG. 19 is a schematic diagram illustrating a scan stage, GBTn1′, according to another embodiment of the present disclosure. The scan stage GBTn1′ may include transistors GT1, GT2, GT3, GT4, GT5, GT6, and GT7 and capacitors GC1, GC2, and GC3.

The first transistor GT1 may have a first electrode connected to the output terminal 01, a second electrode receiving the second voltage VGL, and a gate electrode connected to a second electrode of the seventh transistor GT7.

The first capacitor GC1 may have a first electrode connected to a first electrode of the first transistor GT1 and a second electrode connected to a gate electrode of the first transistor GT1.

The second transistor GT2 may have a first electrode receiving the first voltage VGH, the second electrode connected to the output terminal 01, and a gate electrode connected to the node QBN.

The third transistor GT3 may have a first electrode connected to the first input terminal 11, a second electrode connected to the node QN, and a gate electrode connected to the second input terminal I2.

The fourth transistor GT4 may have a first electrode receiving the first voltage VGH, a second electrode connected to the node SR_QBN, and a gate electrode connected to the first input terminal I1.

The second capacitor GC2 may have a first electrode receiving the first voltage VGH, and a second electrode connected to the node QBN.

The fifth transistor GT5 may have a first electrode connected to the node QBN, a second electrode connected to the second input terminal 12, and a gate electrode connected to the node SR_QBN.

The third capacitor GC3 may have a first electrode connected to a gate electrode of the fifth transistor GT5 and a second electrode connected to a second electrode of the fifth transistor GT5.

The sixth transistor GT6 may have a first electrode receiving the first voltage VGH, a second electrode connected to the node QBN, and a gate electrode connected to the node QN.

The seventh transistor GT7 may have a first electrode connected to the node QN, a second electrode connected to a gate electrode of the first transistor GT1, and a gate electrode receiving the second voltage VGL.

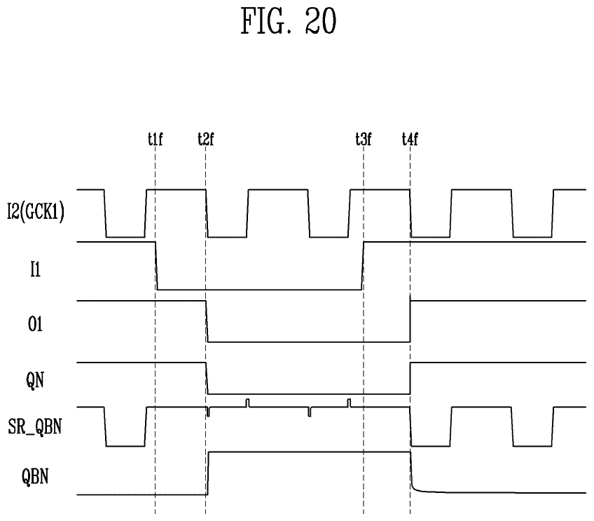

FIG. 20 is a signal/timing diagram illustrating a driving method of a scan stage of FIG. 19.

At time tif, the second scan signal at the turn-on level (low level) output from the previous scan stage may be input to the first input terminal I1. At this time, since the first scan clock signal of the first scan clock line GCK1 connected to the second input terminal 12 may be a high level, the third transistor GT3 may be turned off. Accordingly, the voltage of the node QN may be maintained.

At time t2f, the first scan clock signal may be decreased to a low level. Accordingly, the third transistor GT3 may be turned on, and the voltage level of the node QN may be decreased to a low level. At this time, since the sixth transistor GT6 is turned on, the voltage level of the node QBN may increase depending on the first voltage VGH. Accordingly, the second transistor GT2 may be turned off. Additionally, the first transistor GT1 may be turned on, and the second voltage VGL may be applied to the output terminal 01. Accordingly, the scan stage GBTn1′ may output the second scan signal at the turn-on level (low level).

At time t3f, the second scan signal at the turn-off level (high level) output from the previous scan stage may be input to the first input terminal I1. At this time, since the first scan clock signal of the second input terminal 12 is at a high level, the third transistor GT3 may be turned off. Accordingly, the voltage of the node QN may be maintained.

At time t4f, the first scan clock signal may be increased to a low level. Accordingly, the third transistor GT3 may be turned on, and the voltage level of the node QN may be increased to a high level. Accordingly, the first transistor GT1 may be turned off.

At this time, the voltage of the node QBN connected to the second input terminal 12 may be decreased to a low level through the turned-on fifth transistor GT5. Accordingly, the second transistor GT2 may be turned on, and the first voltage VGH may be applied to the output terminal 01. Accordingly, the scan stage GBTn1′ may output the second scan signal at the turn-off level (high level).

Since the driving method of the second scan driver 13 GB′, which includes the scan stage GBTn1′ of FIG. 19, is the same as that of FIG. 17, redundant description will be omitted.

The drawings and the description of the present disclosure are intended to be illustrative; they are not intended to limit the meaning or the scope of the present inventive concept as recited in the appended claims, but merely provided to facilitate understanding. Therefore, it will be understood by those skilled in the art that various modifications and equivalent other embodiments are possible therefrom. Hence, the scope of the present inventive concept shall be determined by the accompanying claims.

What is claimed is:

1. A display device comprising:
a first scan driver configured to transmit first scan signals at a turn-on level during first scan periods and to maintain the first scan signals at a turn-off level throughout second scan periods;
a light emitting driver configured to transmit light emitting signals at a turn-off level to overlap the first scan signals at the turn-on level during the first scan periods and to transmit the light emitting signals at the turn-off level during the second scan periods; and
pixels configured to receive data voltages in response to the first scan signals at the turn-on level and to be in a non-emitting state in response to the light emitting signals at the turn-off level,
wherein,
the light emitting driver includes a plurality of light emitting stages,
during the first scan periods, the light emitting stages sequentially generate light emitting signals of the turn-off level in units of one light emitting stage, and
during the second scan periods, the light emitting stages sequentially generate light emitting signals of the turn-off level in units of m light emitting stages, where m is an integer greater than 1.

2. The display device of claim 1, wherein the integer m is a multiple of 2.

3. The display device of claim 1, wherein:
the light emitting driver is connected to a first light emitting clock line, a second light emitting clock line, a third light emitting clock line, and a fourth light emitting clock line,
each of the light emitting stages includes:
a first input terminal that receives a light emitting signal at the turn-off level output from another light emitting stage,
a second input terminal connected to one of the first light emitting clock line, the second light emitting clock line, the third light emitting clock line, and the fourth light emitting clock line,
a third input terminal connected to another of the first light emitting clock line, the second light emitting clock line, the third light emitting clock line, and the fourth light emitting clock line, and
an output terminal that outputs a light emitting signal at the turn-off level during a portion of each of the first and second scan periods, and
two light emitting stages adjacent to each other are connected to different ones of the first to fourth light emitting clock lines.

4. The display device of claim 3, wherein:
the light emitting driver includes first and second light emitting stage groups,
the first light emitting stage group includes m light emitting stages,
the second light emitting stage group is adjacent to the first light emitting stage group and includes m different light emitting stages, and
a structure in which the second light emitting stage group is connected to the light emitting clock lines is mirror symmetrical to a structure in which the first light emitting stage group is connected to the light emitting clock lines.

5. The display device of claim 4, wherein
a m-1-th light emitting stage of the first light emitting stage group has a second input terminal connected to the first light emitting clock line and a third input terminal connected to the second light emitting clock line,
a m-th light emitting stage of the first light emitting stage group has a second input terminal connected to the third light emitting clock line and a third input terminal connected to the fourth light emitting clock line,
a first light emitting stage of the second light emitting stage group has a second input terminal connected to the fourth light emitting clock line and a third input terminal connected to the third light emitting clock line, and
a second light emitting stage of the second light emitting stage group has a second input terminal connected to the second light emitting clock line and a third input terminal connected to the first light emitting clock line.

6. The display device of claim 5, wherein a frequency of light emitting clock signals applied to the light emitting clock lines during the first scan periods is m times a frequency of the light emitting clock signals applied to the light emitting clock lines during the second scan periods.

7. The display device of claim 6, wherein:
during the first scan periods, a first light emitting clock signal applied to the first light emitting clock line is the same as a fourth light emitting clock signal applied to the fourth light emitting clock line, and a second light emitting clock signal applied to the second light emitting clock line is the same as a third light emitting clock signal applied to the third light emitting clock line, and
during the second scan periods, the first light emitting clock signal is the same as the third light emitting clock signal, and the second light emitting clock signal is the same as the fourth light emitting clock signal.

8. The display device of claim 1, wherein:
the light emitting driver further includes a light emitting stage connection circuit configured to receive an enable signal during the first scan periods and a disable signal during the second scan periods,
when receiving the enable signal, the light emitting stage connection circuit connects each of first input terminals of the light emitting stages to an output terminal of a previous light emitting stage, and
when receiving the disable signal, the light emitting stage connection circuit connects each of the first input terminals of the light emitting stages to an output terminal of a previous light emitting stage group.

9. The display device of claim 8, wherein the light emitting stage connection circuit includes:
first connection transistors that are turned on when receiving the enable signal and connect each of the first input terminals of the light emitting stages to the output terminal of the previous light emitting stage, and
second connection transistors that are turned on when receiving the disable signal and connect each of the first input terminals of the light emitting stages to the output terminal of the previous light emitting stage group.

10. The display device of claim 9, wherein:
the first connection transistors are each a P-type or an N-type transistor,
the second connection transistors are each the other of a P-type or N-type transistor,
gate electrodes of the first connection transistors and of the second connection transistors are commonly connected to an enable line,
the enable signal and the disable signal are applied to the enable line,
the enable signal is a biasing signal that turns on the first connection transistors, and
the disable signal is a biasing signal that turns on the second connection transistors.

11. A display device comprising:
a first scan driver configured to transmit first scan signals at a turn-on level during first scan periods and to maintain the first scan signals at a turn-off level throughout second scan periods;
a second scan driver configured to transmit second scan signals at a turn-on level during the first scan periods and to transmit second scan signals at the turn-on level during the second scan periods; and
pixels configured to receive data voltages in response to the first scan signals at the turn-on level and to initialize an anode voltage of a light emitting element in response to the second scan signals at the turn-on level,
wherein,
the second scan driver includes a plurality of scan stages,
during the first scan periods, the scan stages sequentially generate second scan signals at the turn-on level in units of one scan stage, and
during the second scan periods, the scan stages sequentially generate second scan signals at the turn-on level in units of m scan stages, where m is an integer greater than 1.

12. The display device of claim 11, wherein m is a multiple of 2.

13. The display device of claim 11, wherein:
the second scan driver is connected to a first scan clock line, a second scan clock line, a third scan clock line, and a fourth scan clock line,
each of the scan stages includes:
a first input terminal that receives a second scan signal at the turn-on level output from another scan stage,
a second input terminal connected to one of the first scan clock line, the second scan clock line, the third scan clock line, and the fourth scan clock line,
a third input terminal connected to another one of the first scan clock line, the second scan clock line, the third scan clock line, and the fourth scan clock line, and
an output terminal that outputs a second scan signal at the turn-on level, and
two scan stages adjacent to each other are connected to different scan clock lines.

14. The display device of claim 13, wherein:
a m-1-th scan stage of the first scan stage group has a second input terminal connected to the first scan clock line and a third input terminal connected to the second scan clock line,
a m-th scan stage of the first scan stage group has a second input terminal connected to the third scan clock line and a third input terminal connected to the fourth scan clock line,
a first scan stage of the second scan stage group has a second input terminal connected to the fourth scan clock line and a third input terminal connected to the third scan clock line, and
a second scan stage of the second scan stage group has a second input terminal connected to the second scan clock line and a third input terminal connected to the first scan clock line.

15. The display device of claim 14, wherein a frequency of scan clock signals applied to the scan clock lines during the first scan periods is m times a frequency of the scan clock signals applied to the scan clock lines during the second scan periods.

16. The display device of claim 15, wherein:
during the first scan periods, a first scan clock signal applied to the first scan clock line is the same as a fourth scan clock signal applied to the fourth scan clock line, and a second scan clock signal applied to the second scan clock line is the same as a third scan clock signal applied to the third scan clock line, and
during the second scan periods, the first scan clock signal is the same as the third scan clock signal, and the second scan clock signal is the same as the fourth scan clock signal.

17. The display device of claim 11, wherein:
the second scan driver is connected to a first scan clock line, a second scan clock line, a third scan clock line, and a fourth scan clock line,
each of the scan stages includes:
a first input terminal that receives a second scan signal at the turn-on level output from another scan stage,
a second input terminal that is connected to one of the first scan clock line, the second scan clock line, the third scan clock line, and the fourth scan clock line, and
an output terminal that outputs a second scan signal at the turn-on level, and
two scan stages adjacent to each other are connected to different scan clock lines.

18. The display device of claim 15, wherein:
a m-1-th scan stage of the first scan stage group has a second input terminal connected to the first scan clock line,
a m-th scan stage of the first scan stage group has a second input terminal connected to the third scan clock line,
a first scan stage of the second scan stage group has a second input terminal connected to the fourth scan clock line, and
a second scan stage of the second scan stage group has a second input terminal connected to the second scan clock line.

19. The display device of claim 11, wherein:
the second scan driver further includes a scan stage connection circuit that receives an enable signal during the first scan periods and a disable signal during the second scan periods,
when receiving the enable signal, the scan stage connection circuit connects each of first input terminals of the scan stages to an output terminal of a previous scan stage, and
when receiving the disable signal, the scan stage connection circuit connects each of the first input terminals of the scan stages to an output terminal of a previous scan stage group.

20. The display device of claim 19, wherein the scan stage connection circuit includes:
first connection transistors that are turned on when receiving the enable signal and connect each of the first input terminals of the scan stages to the output terminal of the previous scan stage, and
second connection transistors that are turned on when receiving the disable signal and connect each of the first input terminals of the scan stages to the output terminal of the previous scan stage group.
